(19) United States
(12) Patent Application Publication
(10) Pub. No.: US 2019/0327408 A1
(43) Pub. Date: Oct. 24, 2019

(54) IMAGE PROCESSING APPARATUS, IMAGING APPARATUS, AND IMAGE PROCESSING METHOD

(71) Applicant: CANON KABUSHIKI KAISHA, Tokyo (JP)

(72) Inventor: Masahiro Kawarada, Tokyo (JP)

(21) Appl. No.: 16/381,092

(22) Filed: Apr. 11, 2019

(30) Foreign Application Priority Data
Apr. 20, 2018 (JP) 2018-081063

(51) Int. Cl. H04N 5/232; G06F 9/30

(52) U.S. Cl. CPC H04N 5/23212; G06F 9/3004; H04N 5/23229

(57) ABSTRACT

An image processing apparatus includes an acquirer configured to acquire index information as an evaluation index of an imaging opportunity for each of a plurality of image data acquired by consecutive capturing of a moving object, and an evaluator configured to evaluate each of the plurality of image data using the index information.

### BACKGROUND OF THE INVENTION

### Field of the Invention

The present invention relates to a technology to automatically classify image data captured through imaging (image capturing), based on a focus detection result.

### Description of the Related Art

A method of classifying and recording a plurality of images acquired by imaging based on the sharpness has been proposed. Japanese Patent Laid-Open No. (“JP”) 2004-320487 discloses an imaging apparatus that consecutively captures a plurality of still images with a fixed focus position, automatically selects and records one image having the highest AF (autofocus) evaluation value corresponding to a high frequency component among the obtained plurality of still images, in a recording area for storage. This imaging apparatus records an unselected still image in a recording area for deletion use.

The imaging apparatus disclosed in JP 2004-320487 preferentially records in-focus images among a plurality of images obtained by consecutive capturing, and it is unnecessary for the user to select an image having a good focus state from the plurality of images. Nevertheless, this imaging apparatus may not select an image intended by the user. Since the captured image is obtained through consecutive capturing at the fixed focus position, it is estimated that the captured image with the highest AF evaluation value has the best focus state. However, the highest AF evaluation value means the relatively higher focus state among the plurality of images acquired by the imaging, and does not mean that the object intended by the user is always focused.

In consecutively capturing an object moving in a depth direction with a focus position changed, an object image magnification varies as the object distance (imaging distance) varies because the object distance depends on the focus position. As the object image magnification varies, the spatial frequency characteristic of the object varies and the image composition itself also varies, so the level of the AF evaluation value of the image fluctuates and the focus states cannot be compared with each other simply based on the AF evaluation value.

### SUMMARY OF THE INVENTION

The present invention provides an image processing apparatus, an imaging apparatus, and an image processing method, each of which can properly evaluate a plurality of image data acquired by consecutive capturing.

An image processing apparatus according to one aspect of the present invention includes an acquirer configured to acquire index information as an evaluation index of an imaging opportunity for each of a plurality of image data acquired by consecutive capturing of a moving object, and an evaluator configured to evaluate each of the plurality of image data using the index information.

An imaging apparatus according to another aspect of the present invention includes an image sensor configured to consecutively capturing images, and the above image processing apparatus. An image processing method corresponding to the above image processing apparatus and a storage medium storing the image processing method also constitute another aspect of the present invention.

Further features of the present invention will become apparent from the following description of exemplary embodiments with reference to the attached drawings.

### BRIEF DESCRIPTION OF THE DRAWINGS

FIG. 1 illustrates a configuration of a digital camera according to a first embodiment of the present invention.

FIG. 2 illustrates an imaging plane in the digital camera according to the first embodiment viewed from a light incidence side.

FIGS. 3A and 3B illustrate a configuration of a pixel portion on the imaging plane according to the first embodiment.

FIG. 4 illustrates a phase difference of a phase difference image signal obtained from focus detecting pixels in an in-focus state according to the first embodiment.

FIG. 5 illustrates the phase difference of the phase difference image signal obtained from the focus detecting pixels in a defocus state according to the first embodiment.

FIG. 6 illustrates an optical system in a focus detecting unit in FIG. 1.

FIG. 7 illustrates an illustrative structure of JPEG image data.

FIG. 8 is a flowchart of processing executed by the digital camera according to the first embodiment.

FIG. 9 is a flowchart of primary rating processing according to the first embodiment.

FIG. 10 illustrates a relationship between an absolute value of a defocus amount and a grade in the primary rating processing according to the first embodiment.

FIG. 11 is a flowchart of secondary rating processing according to the first embodiment.

FIG. 12 illustrates an illustrative distribution of primary grades based on the defocus amount according to the first embodiment.

FIG. 13 is a table showing an illustrative transition of quality of an imaging opportunity according to the first embodiment.

FIG. 14 is a graph illustrating an illustrative transition of the quality of the imaging opportunity.

FIG. 15 is a table for explaining provisional rating and secondary rating according to the first embodiment.

FIG. 16 is a graph for explaining provisional rating and secondary rating according to the first embodiment.

FIGS. 17A and 17B are a flowchart of processing executed by the digital camera according to a second embodiment of the present invention.

FIG. 18 illustrates a configuration of a computer (image processing apparatus) according to a third embodiment of the present invention.

FIG. 19 is a flowchart of processing executed by the computer according to the third embodiment.

### DESCRIPTION OF THE EMBODIMENTS

Referring now to the accompanying drawings, a detailed description will be given of a variety of embodiments according to the present invention.

### First Embodiment

### <Configuration of Digital Camera>

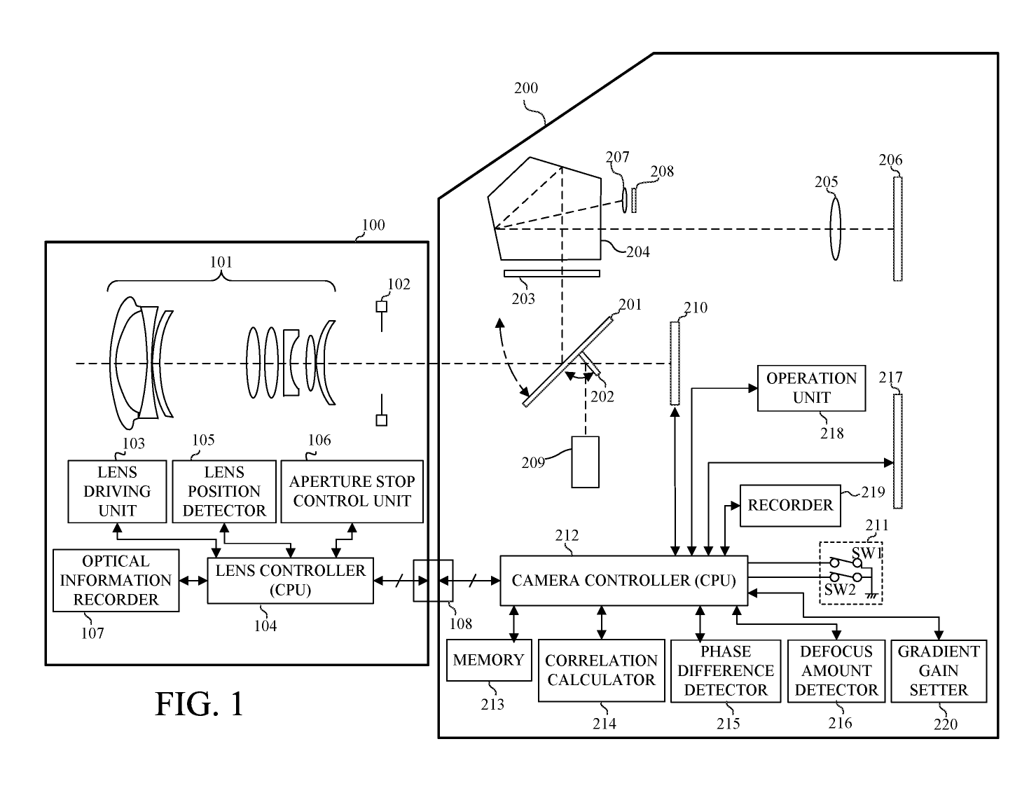

FIG. 1 illustrates a configuration of a digital camera as an imaging apparatus according to a first embodiment of the present invention. The digital camera includes a lens unit portion 100 and a camera portion 200. The lens unit portion 100 is detachably attached to the camera portion 200 via a lens mount mechanism provided on an unillustrated mount unit. An electric contact unit 108 is provided in the mount portion. The electrical contact unit 108 includes a communication bus line terminal including a communication clock line, a data transmitting line, a data receiving line, and the like, and the lens unit portion 100 and the camera portion 200 are communicatively connected by the communication bus line terminal.

The lens unit portion 100 includes an imaging optical system. The imaging optical system includes a lens portion 101 including a zoom lens and a focus lens that move in the optical axis direction for zooming (magnification variation) and focusing, and an aperture stop (diaphragm) 102 that controls a light amount. The lens unit portion 100 further includes a driving system using, as a driving source, a stepping motor configured to move the zoom lens and the focus lens, and a lens driving unit 103 including an electric circuit configured to drive the driving source. The lens unit portion 100 includes a lens position detector 105 that obtains a signal waveform indicating a phase of the stepping motor in the lens driving unit 103 through a lens controller 104, and detects the positions of the zoom lens and the focus lens. The lens portion 101, the lens driving unit 103, and the lens position detector 105 constitute a focusing unit.

The lens unit portion 100 further includes an aperture stop control unit 106 configured to control the aperture stop 102, and an optical information recorder 107 configured to record a variety of optical design values of the lens portion 101 and the aperture stop 102. The lens driving unit 103, the aperture stop control unit 106, and the optical information recorder 107 are connected to a lens controller 104, such as a CPU, that controls the entire operation of the lens unit portion 100.

The camera portion 200 communicates with the lens unit portion 100 via the electrical contact unit 108, transmits zoom and focus control requests of the lens portion 101 and a control request of the aperture stop 102 to the lens unit portion 100, and receives the control result from the lens unit portion 100.

A light flux entering the imaging optical system passes through the lens portion 101 and the aperture stop 102 and is guided to a main mirror 201 in the camera portion 200. The main mirror 201 includes a half-mirror, and when it is obliquely disposed on the optical path from the imaging optical system (while this state will be referred to as a mirror-down state hereinafter) as illustrated in FIG. 1, focuses half the incident light flux on a focus plate 203 and transmits the other half toward a sub mirror 202. The main mirror 201 can move upwardly as indicated by a double-headed arrow in FIG. 1 to retreat from the optical path (while this state will be referred to as mirror-up state hereinafter). The sub mirror 202 also moves to the mirror-up state as indicated by the double-headed arrow in the figure and retreats to the outside of the optical path.

The focus plate 203 is a diffusing plate disposed at a position optically conjugate with an image capturer 210, which will be described later, and a light beam from the imaging optical system forms an object image on the focus plate 203. The light flux (object image) that has transmitted through the focus plate 203 is converted into an erect image by a pentaprism 204, passes through an eyepiece 205, and reaches a viewfinder 206. The user can observe the object image formed on the focus plate 203 through the viewfinder 206 and the eyepiece 205.

Part of the light beam entering the pentaprism 204 passes through a photometric imaging lens 207 and enters a photometric sensor 208 that measures the luminance of the object image. The photometric sensor 208 includes an unillustrated photoelectric conversion element and an unillustrated processor that calculates the luminance from the electric charges obtained by the photoelectric conversion element. The photometric sensor 208 obtains two-dimensional monochromatic multi-gradation image data from the electric charges obtained from the photoelectric conversion element. This monochromatic multi-gradation image data is stored in a memory 213 for later reference by various modules.

In the mirror-down state, the sub mirror 202 guides the reflected light flux to the focus detecting unit 209. The focus detecting unit 209 performs a focus detection in the focus detecting area by the phase difference detection method. The focus detecting area is a single area, such as a center portion of the imaging angle of view.

On the other hand, in the mirror-up state, the light flux entering the imaging optical system passes through the lens portion 101 and the aperture stop 102 and reaches the image capturer 210 in the camera portion 200. The image capturer 210 includes an image sensor as a two-dimensional photoelectric conversion element, and a processor that generates image data from the image signal output from the image sensor and performs various image processing, such as a luminance correction, for the imaging data. The detailed configuration of the image capturer 210 will be described later.

The camera portion 200 includes an operation switch 211 to be operated by the user. The operation switch 211 is a two-step stroke type switch, and an imaging preparation operation such as the photometry and focusing is started in the mirror-down state by the ON operation of (or by turning on) the first stage (SW1). The main mirror 201 and the sub mirror 202 are moved to the mirror-up state by the ON operation of (or by turning on) the second stage (SW2), and the imaging operation starts. When the ON operation of the SW2 continues in a still-image consecutive-capturing mode described later, consecutive capturing including a plurality of capturers is performed.

A correlation calculator 214 performs a correlation operation for a pair of phase difference image signals (two image signals) obtained from the focus detecting unit 209 or the image capturer 210 to calculate a correlation value for each shift amount between the two image signals. The phase difference detector 215 calculates a shift amount indicating a correlation with the highest calculated correlation value or a phase difference (image shift amount). The defocus amount detector 216 calculates a defocus amount of the imaging optical system based on the phase difference calculated by the phase difference detector 215 and the optical characteristic of the imaging optical system.

A camera controller 212 transmits and receives control information to and from the lens controller 104 via the electric contact unit 108, and drives and controls the lens portion 101 based on the defocus amount calculated by the defocus amount detector 216. Thereby, the focus position of the imaging optical system is controlled (or AF is performed).

The digital camera according to this embodiment has a display unit 217 for displaying the object image captured by the image capturer 210 and a variety of operation statuses. The digital camera has a still-image single-capturing mode, a still-image consecutive-capturing mode, a live-view mode, and a motion image recording mode, as imaging operation modes, and possesses the operation unit 218 to be operated by the user in switching the imaging operation mode. The operation unit 218 can also input an instruction to start or end motion image recording. The digital camera has a focus detection mode including a single-capturing AF mode and a servo AF mode, which will be described later, and the user can select the focus detection mode through the operation unit 218.

### <Image Capturer 210>

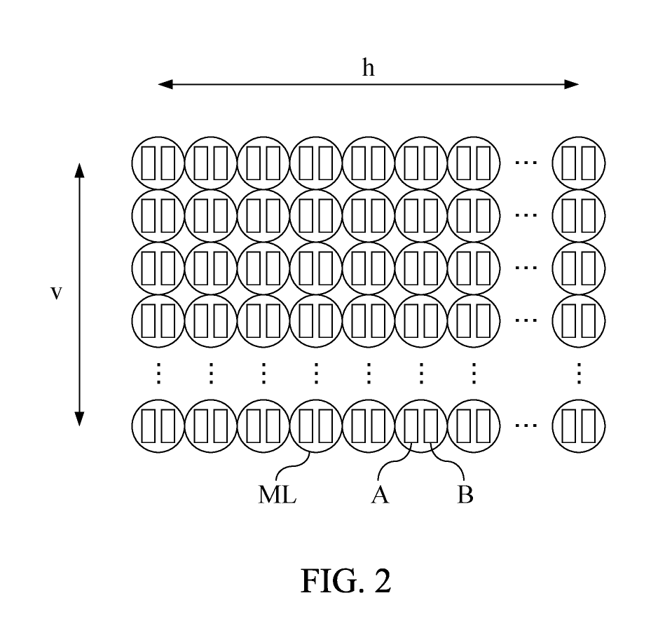

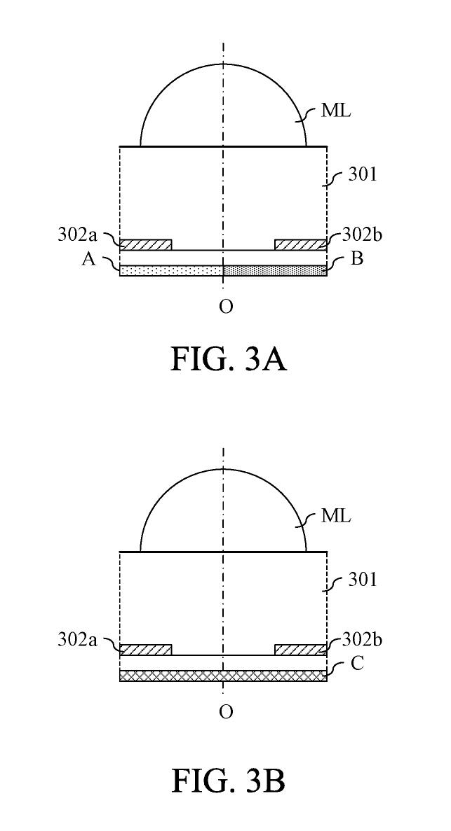

Referring now to FIGS. 2, 3A, and 3B, a description will be given of the configuration of the imaging plane of the image sensor in the image capturer (imaging portion or unit) 210. FIG. 2 illustrates an imaging plane viewed from the light incident side. The image capturer 210 has a plurality of pixel units (h pixel portions in the horizontal direction×v pixel portions in the vertical direction).

FIGS. 3A and 3B illustrate the configuration of one pixel portion. Each pixel portion has a first focus detecting pixel A and a second focus detecting pixel B which a pair of light beams divided on the exit pupil plane in the imaging optical system enter, respectively. A single micro lens ML as a condenser is disposed in front of the first focus detecting pixel A and the second focus detecting pixel B. Each pixel portion has a color filter (not illustrated) of red, green, and blue in the Bayer array.

In the pixel portion, a smooth layer 301 is a plane for forming the micro lens ML. Light shielding layers 302a and 302b are arranged to prevent unnecessary light beams at oblique angles from entering the first focus detecting pixel A and the second focus detecting pixel B. The first focus detecting pixel A and the second focus detecting pixel B respectively receive, with a parallax, light beams from mutually different pupil regions on the exit pupil in the imaging optical system, which are symmetrical with respect to a center O in the pixel portion, and output electric charges (pixel signals). When the charges (image signal) for an imaging pixel C can be obtained by adding the charges of the first focus detecting pixel A and the charges of the second focus detecting pixel B to each other, as illustrated in FIG. 3B.

### <Principle of Focus Detection by Imaging-Plane Phase Difference Detection Method>

A first focus detecting pixel array in which a plurality of first focus detecting pixels A are arranged and a second focus detecting pixel array in which a plurality of second focus detecting pixels B are arranged form a mutual pair in the image sensor. As the number of pixels in the image sensor increases, a pair of approximated object images (two images) are formed on the pair of first and second focus detecting pixel arrays. A row of phase difference image signals (referred to as an A image signal hereinafter) is generated by combining the pixel signals from the plurality of first focus detecting pixels A in the first focus detecting pixel row. A row of phase difference image signals (referred to as a B image signal hereinafter) is generated by combining the pixel signals from the plurality of second focus detecting pixels B in the second focus detecting pixel row. In the in-focus state in which the imaging optical system is focused on the object, the A image signal and the B image signal coincide with each other.

On the other hand, in the defocus state where the imaging optical system is defocused from the object, there is a phase difference between the A image signal and the B image signal. The phase difference direction is opposite between the front focus state in which the imaging position is located on the front side of the expected focal plane and the rear focus state in which the imaging position is located on the far side of the expected focal plane.

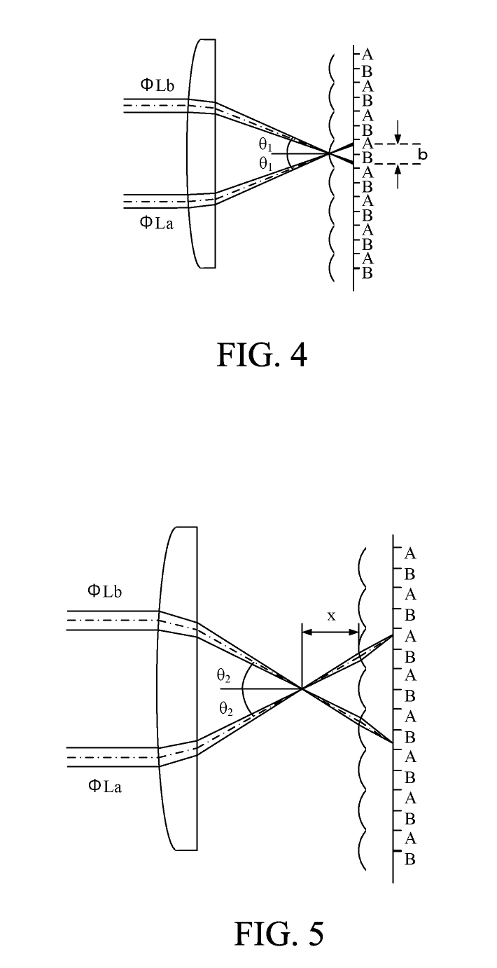

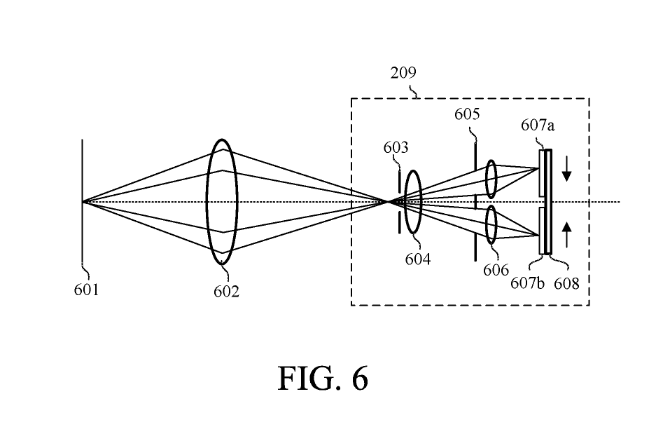

FIG. 4 illustrates the phase difference between the A image signal and the B image signal in the in-focus state in a certain pixel portion. FIG. 5 illustrates the phase difference between the A image signal and the B image signal in a defocus state in the certain pixel portion. In FIGS. 4 and 5, the first focus detecting pixel A is expressed by A and the second focus detecting pixel B is expressed by B.

The light flux from the object (one point) is divided into a light flux φLa entering the first focus detecting pixel A through the pupil region corresponding to the first focus detecting pixel A and a light flux ΦLb entering the second focus detecting pixel B through the pupil region corresponding to the second focus detecting pixel B. Since these two light fluxes are incident from the same point on the object, the two light beams enter the same micro lens ML at an incident angle θ₁, pass through it, and reach one point on the image sensor in the in-focus state of the imaging optical system, as illustrated in FIG. 4. Hence, the A image signal and the B image signal coincide with each other.

On the other hand, as illustrated in FIG. 5, in a defocus state with x, the arrival positions of the two light fluxes ΦLa and ΦLb shift from each other by an amount corresponding to incident angles of the light fluxes ΦLa and ΦLb on the micro lens ML changing from θ₁ to θ₂. Thus, there is a phase difference between the A image signal and the B image signal. Then, the focus detection by the imaging-plane phase difference detection method calculates the phase difference through the correlation calculation to the A image signal and the B image signal, and the defocus amount based on the phase difference.

### <Focus Detecting Unit 209>

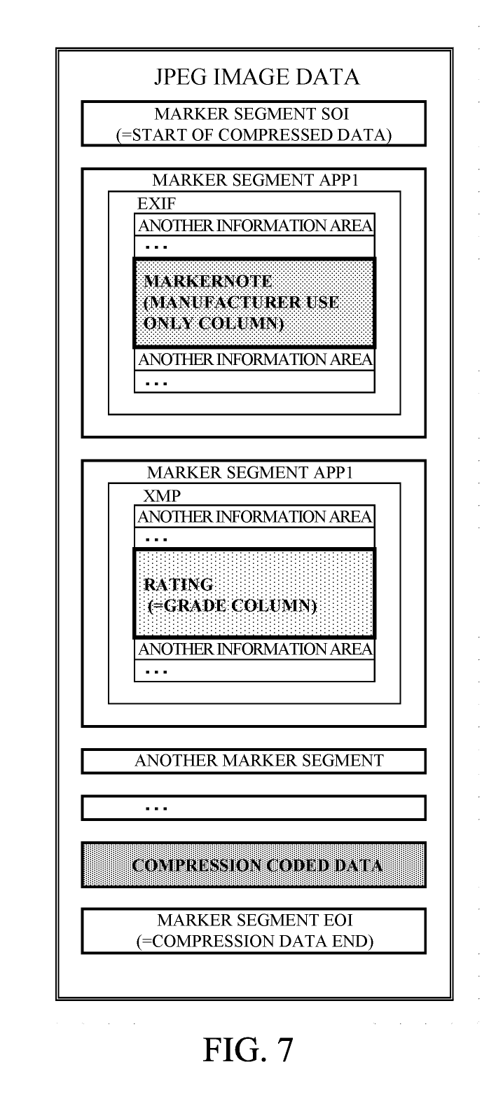

Referring now to FIG. 6, a description will be given of an optical system in the focus detecting unit 209. In FIG. 6, the light flux emitted from an object plane 601 passes through an imaging optical system 602 including the lens portion 101 and the aperture stop 102, and the main mirror 201, is reflected by the sub mirror 202, and enters the focus detecting unit 209. The focus detecting unit 209 includes a field mask 603, a field lens 604, a secondary optical system aperture stop 605, secondary imaging lenses 606, and a focus detecting sensor 608 including at least a pair of photoelectric conversion element arrays 607a and 607b.

The light flux entering the focus detecting unit 209 passes through the field mask 603 disposed near the expected imaging plane and enters the field lens 604. The field mask 603 is a light shielding member for preventing unnecessary light flux outside the focus detecting area from entering the photoelectric conversion element arrays 607a and 607b from the field lens 604. The field lens 604 controls the light flux from the imaging optical system 602 in order to suppress dimming and unsharpness of the peripheral portion in the focus detecting area. The light flux having passed through the field lens 604 further passes through the pair of secondary optical system aperture stops 605 and the secondary imaging lenses 606 arranged symmetrically with respect to the optical axis in the imaging optical system 602. Thereby, one part (one of the pair) of light beams passing through the imaging optical system 602 enters the photoelectric conversion element array 607a and the other part (the other pair of) light beams enters the photoelectric conversion element array 607b.

<Principle of Focus Detection based on Signal from Focus Detecting Unit 209>

When the imaging plane of the imaging optical system 602 is located on the front side of the expected imaging plane, the light flux entering the photoelectric conversion element array 607a and the light flux entering the photoelectric conversion element array 607b approach to each other in the direction indicated by arrows in FIG. 6. When the imaging plane of the imaging optical system 602 is behind the expected imaging plane, the light flux entering the photoelectric conversion element array 607a and the light flux entering the photoelectric conversion element array 607b are separated from each other. Thus, a shift amount between the light beam entering the photoelectric conversion element array 607a and the light beam entering the photoelectric conversion element array 607b has a correlation with the in-focus level of the imaging optical system 602. Once the phase difference is calculated between the signal (A image signal) obtained by photoelectrically converting the light beam entering the photoelectric conversion element array 607a and the signal (B image signal) obtained by photoelectrically converting the light beam entering the photoelectric conversion element array 607b, the defocus amount can be calculated from the phase difference. Thereby, the focus detection using the phase difference detection method can be performed.

### <Recording Method of Attribute Information in Image Data>

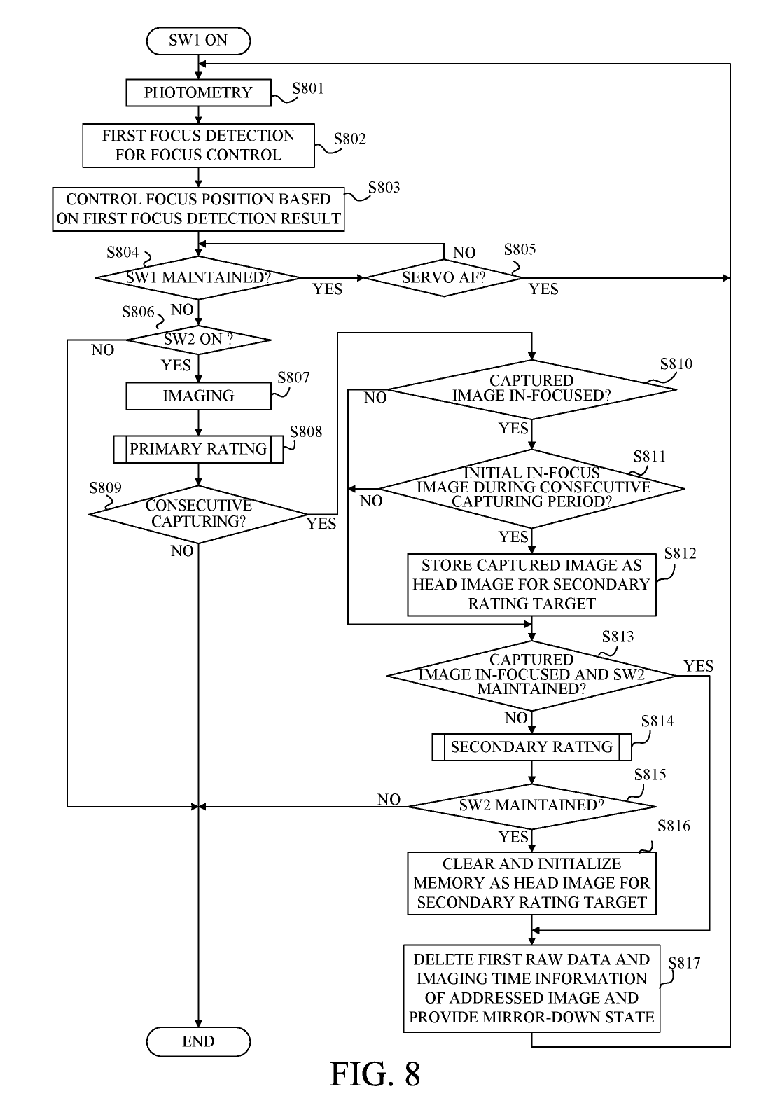

FIG. 7 illustrates an illustrative structure of image data in storing image data obtained by imaging by the JPEG format. The content of the data string in the image data of the JPEG format can be recognized by segmenting the data string of various information with marker segments represented by the byte string. As illustrated in FIG. 7, a marker segment “SOI” indicating a start of compressed data is described as a header of the image data in the JPEG format, and a marker segment “APP1” indicating the attribute information in the image data is described next. In addition, various information such as a quantization table and a Huffman table of the compressed image data and marker segments different from “APP1” are described. Finally, the data string of the compressed and coded image and the marker segment “EOI” indicating an end of the compressed data are described.

The marker segment “APP1” indicating the attribute information of the image data can describe the “MakerNote” (manufacturer use only) field and other attribute information by the Exif format described in General Incorporated Association, Camera & Imaging Products Association, Exchangeable image file format for digital still cameras: Exif Version 2.31 (CIPA DC-008-2016) (“Literature 1”). The “MakerNote” field can freely describe various information as long as the manufacturer keeps the image file format standard. Despite the description freedom degree, it has a characteristic in low compatibility with other manufacturers. This recording system corresponds to a first recording method.

The marker segment “APP1” can describe a “Rating” field and other attribute information by the XMP format (Adobe XMP standard) described in “Extensible Metadata Platform (XMP) Specification” Part 1 to Part 3, Adobe Systems Incorporated (“Literature 2”). The “Rating” field can describe totally seven grades (evaluation results) of 0 to 5 as standard values and −1 as an explicitly non-rated value. This rating enables partial images with high grades from images including, for example, a large number of captured images to be extracted and preferentially treated. The description mode and the number of grades in the “Rating” field are predetermined with small freedom degrees but provide high compatibility with other manufacturers. This recording system corresponds to a second recording method. The first recording method has grades (evaluation stages) more than those of the second recording method.

The marker segment “APP1” can use the description of the Exif format and the description of the XMP format together, and in this case, the same marker segment “APP1” is provided for each description format individually. The recording mode of segmenting the data strings of various information with such marker segments is also used in TIFF and other image file formats in addition to the JPEG format.

### <Imaging Operation Modes of Digital Camera>

The digital camera according to this embodiment has a still-image single-capturing mode and a still-image consecutive-capturing mode, which are different in operations from imaging to recording. Each mode will be described below.

### <Still-Image Single-Capturing Mode>

The still-image single-capturing mode in this embodiment is a mode that provides a single still image in response to the ON operation of the SW2 in the operation switch 211. In the still-image single-capturing mode, the camera controller 212 controls the main mirror 201 to provide the mirror-down state and to enable the user to visually confirm the object image through the viewfinder 206. The light flux from the object is guided to the focus detecting unit 209 by the sub mirror 202.

In response to the ON operation of the SW1 in the operation switch 211 in the still-image single-capturing mode, a first photometry (light metering) operation measures the luminance of the object image with the photometric sensor 208, and determines the aperture diameter of the aperture stop 102 and the charge accumulation time and the ISO speed of the image capturer 210 based on the photometric result. Following the first photometry operation, the first focus detection is performed by the focus detecting unit 209, and the focus position of the lens portion 101 is controlled based on the obtained focus detection result (first focus detection result).

In response to the ON operation of the SW2 in the still-image single-capturing mode, the aperture stop 102 is controlled to the aperture diameter determined based on the photometry result of the first photometry operation. At the same time, the main mirror 201 and the sub mirror 202 are moved to the mirror-up state. In the mirror-up state, an imaging operation is performed in which the image capturer 210 acquires the image signal with the charge accumulation time and the ISO speed determined by the photometric result of the first photometry operation.

The image capturer 210 generates first RAW data as pupil division image data from the image signal obtained by photoelectrically converting the object image formed by the imaging optical system. The first RAW data is obtained by photoelectrically converting each of a pair of object light fluxes divided on the exit pupil plane, and serves as image data including the signal corresponding to the first focus detecting pixel A and the signal corresponding to the second focus detecting pixel B (or a pair of pixel signals) in each pixel portion. The first RAW data is temporarily stored in the memory 213 connected to the camera controller 212.

The first RAW data temporarily stored in the memory 213 is sent to the correlation calculator 214 connected to the camera controller 212 and used for a second focus detection based on the first RAW data.

The camera controller 212 converts the first RAW data into a file format for a RAW file for recording and generates the second RAW data for recording. The second RAW data corresponds to the first RAW data (pupil division image data), and records an imaging condition (such as an F-number (or aperture value)) and attribute information. The second RAW data is recorded in the recorder 219.

The camera controller 212 adds the A image signal and the B image signal included in the second RAW data to each other for each pixel portion, generates the image signal, and performs image processing, such as a development computation, for the image signal. This image processing provides the still image data for recording in a predetermined file format (JPEG file in this embodiment), which is recorded in the recorder 219.

### <Still-Image Consecutive-Capturing Mode>

The still-image consecutive-capturing mode in this embodiment is a mode that repeatedly captures still images as long as the ON operation of the SW2 of the operation switch 211 continues and until the SW2 is turned off. Thereby, a plurality of still images are acquired.

### <AF Mode>

The digital camera according to this embodiment has a single-capturing AF mode and a servo AF mode for the focus detecting modes. A description will now be given of these focus detecting modes.

The single-capturing AF mode is one focus detecting mode that provides a focus position control (referred to as a focus position control hereinafter) for obtaining the in-focus state only once in response to the ON operation of the SW1 in the operation switch 211. After the focus position control is completed, the focus position is fixed as it is while the ON state of the SW1 continues. In this embodiment, the camera controller 212 controls the focus position in the single-capturing AF mode during the still-image single-capturing mode.

The servo AF mode is another focus detection mode that repeatedly provides the focus position controls while the ON operation of the SW1 in the operation switch 211 continues. Thereby, the focus position can follow the moving object. The focus position control ends in response to the release of the ON operation of SW1 or the ON operation of the SW2. In this embodiment, the camera controller 212 performs the focus position control in the servo AF mode during the still-image consecutive-capturing mode.

<Problems to Be Solved By this Embodiment>

While the ON operation of the SW2 in the operation switch 211 continues as in the still-image consecutive-capturing mode, this embodiment solves the problems in extracting and referring to a series of images obtained by imaging in the in-focus state in which the focus position is focused on the moving object.

A description will now be given of characteristics of the focus position control with an example where the still-image consecutive-capturing is performed for an object moving from the infinity (far) side to the near (short distance) side. Where the object existing on the optical object plane moves at a constant velocity from the infinity side to the near side and the focus position control is performed for the object, the moving velocity of the focus position (image plane) to be focused on the object is higher on the near side than that on the infinity side. The image plane moving velocity can be calculated from the difference in the focus detection result in unit time. The image plane moving velocity gradually increases from the infinity side to the near side. Therefore, the focus position control for focusing on the object moving from the infinity side to the near side is likely to maintain higher the accuracy as the focus position focused on the object is closer to the infinity side. Conversely, the focus position control accuracy is likely to be lower as the focus position focused on the object is closer to the near side.

Hence, in capturing images by continuously controlling the focus position as in the still-image consecutive-capturing mode, as the object moves in the perspective (far-and-near) direction, some focus position controls may be accurate but other focus position controls may not be accurate. When the user consecutively captures many images of an object moving in the perspective direction through the long ON operation of the SW2, these many images are likely to contain in-focus images in a range of the predetermined defocus amount and defocus images that deviates from the range. It is arduous for the user to try to extract only the in-focus images through the visual confirmation from among these many images. Accordingly, the camera portion 200 may be further configured to calculate the defocus amount of the object in the image obtained by imaging, and the image may be classified by rating the images or the like according to the calculated defocus amount. This classification can lessen the load of the user extracting the in-focus images out of many images.

However, the classification using only the defocus amount as an index may extract a large number of in-focus images on the infinity side and a small number of in-focus images on the near side due to the characteristic of the focus position control accuracy for the object moving from the infinity side to the near side. For example, a description will be given of a situation where a runner running on a straight line from a start point on the infinity side to a goal point on the near side in a short-distance race is imaged from a position on the near side of the goal point and the in-focus image is extracted only using the defocus amount as the index.

In this scenario, an image to be originally preferentially extracted by the user is an image with a good imaging opportunity (photo opportunity) that captures the runner approaching to the goal point as well as the in-focus image. However, when the in-focus image is extracted only based on the defocus amount as the index, the image near the goal point with an apparently good imaging opportunity is likely to be buried in many in-focus images on the infinity side. Hence, if the in-focus image is extracted only based on the defocus amount as the index, the user needs to arduously determine through the visual confirmation whether it is an image with a good imaging opportunity.

This is applied not only to the short-distance race but also to a car race in which a racing car moving a curve along a running course at a high speed is consecutively captured from the outside of the curve. The racing car approaching to the curve at a high speed from the infinity side is likely to be captured with a highly accurate focus position control. However, when the racing car approaches to both the curve and the user, the focus position control accuracy becomes lower due to the image plane moving velocity relative to the racing car than when the racing car is moving on the infinity side. When the racing car goes through the curve and moves away from the user, only the back of the racing car can be captured. Then, the image to be originally preferentially extracted by the user is not only an in-focus image but also the image with a good imaging opportunity that captures the racing car that moves on the curve and becomes closest to the user. However, if the in-focus image is extracted only based on the defocus amount as the index, the in-focus image with this good imaging opportunity is likely to be buried in many in-focus images on the infinity side.

Accordingly, this embodiment reduces the burden of the user in selecting the images obtained by imaging.

### <Operation of Gradient Gain Setter 220>

As illustrated in FIG. 1, the camera portion 200 includes a gradient gain setter 220 as an acquirer. The gradient gain setter 220 obtains the index information on the quality of the imaging opportunity for a plurality of images (still image data) acquired by consecutive capturing during an in-focus period in which the focus position is changing. The index information on the quality of the imaging opportunity is used as an evaluation index of the imaging opportunity. The gradient gain setter 220 sets the gradient gain based on the acquired index information. A specific example of the index information on the imaging opportunity quality will be described later.

The gradient gain is a gain to be multiplied by a focus level as one rating criterion so as to generate a difference in a grade to be recorded in the attribute information depending on the quality of the imaging opportunity. The gradient gain setter 220 sets the gradient gain so as to include images corresponding to the lowest gain and the highest gain in a gain range with predetermined values 0 to 3 or the like in a plurality of images obtained during a period in which the in-focus state continues.

The index information on the imaging opportunity quality will be described. For example, assume that still images are consecutively captured of a short-distance runner running along an athletic track who approaches from a start point far from the imaging position where the digital camera according to this embodiment performs imaging. Then, the user turns on the SW1 in the operation switch 211 to control the focus position so as to obtain the in-focus state on the runner when the runner stands by at the start point of the athletic track.

Thereafter, the user turns on the SW2 in the operation switch 211 at the timing when the runner starts running, and consecutively capturing him while performing the focus detection and focus position control between the captures to maintain the in-focus state. In this example, the runner reaching the goal point is the best imaging opportunity among the plurality of images acquired by the consecutive capturing. Hence, the gradient gain setter 220 sets the gradient gain as to multiply by the highest gain the in-focus level of the in-focus image acquired just before the user releases the ON operation of the SW2 shortly after the runner reaches the goal point. At this time, the gradient gain setter 220 sets a higher gradient gain to each image as the in-focus duration as index information is longer or the imaging time is later (that is, so as to highly evaluate the imaging opportunity quality).

Thereby, the quality of the imaging opportunity can be estimated based on the in-focus duration, and in rating the images as described later, a higher grade can be set to an image having higher imaging opportunity quality among two or more in-focus images obtained by consecutive capturing. Thus, images can be sorted and confirmed in descending order of imaging opportunity quality among (in-focus) images with good focus states.

The gradient gain setter 220 may determine the quality of imaging opportunity using a length (accumulated value) of the image plane moving amount as the index information by setting the image plane position when the user starts turning on the SW2 in the operation switch 211 as a base point, instead of the above in-focus duration.

A description will now be given of consecutively capturing still images of a racing car moving on a curve at high velocity from the outside of a curve in a racing course in a car race. The user turns on the switch SW2 in the operation switch 211 to start consecutively capturing the racing car moving at a position on the infinity side before it approaches to the curve far from the imaging position where the camera provides imaging and performs the focus detection and focus position control between captures to maintain the in-focus state. Thereafter, the racing car passes through the curve and comes closest to the imaging position. Then, the racing car moves the last of the curve, gradually shows the back body surface to the digital camera, and gradually moves away from the imaging position. Among the plurality of images acquired by consecutive capturing, the moment when the racing car comes closest to the imaging position is the best imaging opportunity.

The gradient gain setter 220 sets the gradient gain to each image so as to multiply by the maximum gain the in-focus level of the in-focus image acquired when the racing car approaches closest to the imaging position. The gradient gain setter 220 sets the gradient gain to each image so that the gradient gain becomes higher according to the length of the image plane moving amount with the focus position of the initial in-focus image set as the base point in the consecutively acquired in-focus images. Thereby, the quality of the imaging opportunity can be estimated based on the length of the image plane moving amount since the in-focus state starts, and in rating the images as described later, a higher grade can be set to an imaging having higher imaging opportunity quality among two or more in-focus images obtained by consecutive capturing. Thus, images can be sorted and confirmed in descending order of imaging opportunity quality among images with good focus states.

When the focus position of the imaging optical system on the object is used as the index information and the focus position falls within a predetermined near range including the near end of the imaging optical system, the quality of the imaging opportunity may be more highly evaluated than that when the focus position is located outside the predetermined near range. The length of the image plane moving amount and the focus position are indexes that change according to the imaging distance to the object to be focused.

By using as index information the size of the object detected using the object recognition method applying the color detection technology, the shape detection technology, or the face detection technology, the quality of the imaging opportunity may be highly evaluated as the size becomes larger. Thereby, in rating the images, a higher grade can be set to an image by considering it has higher imaging opportunity quality when the focus position falls within the predetermined near range or when the object size is larger.

As described above, the image plane moving velocity relative to the object moving at a constant velocity in the perspective direction is higher on the near side than that on the infinity side. Hence, the imaging opportunity quality may be set higher as the image plane movement velocity as the index information becomes higher. Depending on the past changing tend of the focus detection results, the predicted image plane moving velocity at the next consecutive capturing timing (or future imaging time) may be used as the index information. In the sports photography, as the calculated image plane moving velocity and predicted image plane moving velocity are higher, the decisive moment of the object can be expected to be captured and the imaging opportunity can be highly estimated. Thus, a higher grade can be set to the image obtained by imaging at that time by assuming that the imaging opportunity quality is higher as the image plane moving velocity of the object is higher.

Thus, the gradient gain setter 220 sets the gradient gain to each of a plurality of consecutive in-focus images obtained by consecutive capturing using the index information on the above quality of the imaging opportunity. Then, in rating the images based on the in-focus level of the in-focus image, the gradient gain is used to set a final grade such that the in-focus image with higher imaging opportunity quality has a higher grade (more highly evaluated).

### <Operation of Digital Camera>

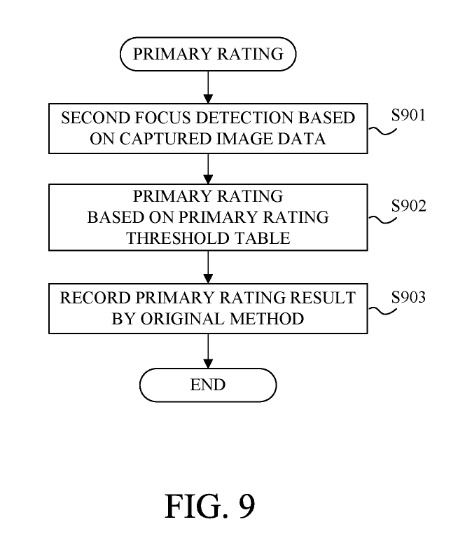

A flowchart in FIG. 8 illustrates processing (imaging operation and image rating operation) executed by the digital camera according to this embodiment. The camera controller 212 executes this processing in accordance with a computer program. The camera controller 212 and the gradient gain setter 220 constitute an image processing apparatus.

Imaging Operation (Steps S801 to S807) In the initial state just after the power is turned on, the digital camera according to this embodiment sets the still-image single-capturing mode or the still-image consecutive-capturing mode in the mirror-down state, and the user can view the object image through the viewfinder 206. First, the user turns on the SW1 in the operation switch 211 to thereby execute the processing for the imaging operation from the step S801.

In the step S801, the camera controller 212 causes the photometric sensor 208 to perform the photometry to obtain the photometric result. Thereafter, the camera controller 212 proceeds to the step S802.

In the step S802, the camera controller 212 causes the focus detecting unit 209 to perform the first focus detection for detecting the defocus amount of the imaging optical system (the lens portion 101) to obtain the defocus amount as the first focus detection result. Thereafter, the camera controller 212 proceeds to the step S803.

In the step S803, the camera controller 212 calculates a focus driving amount as a driving amount of the focus lens in the lens portion 101 based on the first focus detection result obtained in the step S802. The camera controller 212 transmits the calculated focus driving amount to the lens controller 104. The lens controller 104 controls the focus position of the lens portion 101 by moving the focus lens through the lens driving unit 103 based on the received focus driving amount. Thereafter, the camera controller 212 proceeds to the step S804.

The current F-number (aperture value) acquired from the aperture stop control unit 106 through the lens controller 104 may be used to calculate the focus driving amount in the step S803. The focus sensitivity, which is a focus driving amount necessary to move the focus position by an amount corresponding to the unit defocus amount, determined for each position of the focus lens and the magnification variation of the reference focus driving amount that optically changes as the defocus amount increases may be acquired from the optical information recorder 107.

In the step S804, the camera controller 212 detects the operation state of the operation switch 211, and determines whether or not the ON operation of SW1 is maintained. If the ON operation of SW1 is maintained, the camera controller 212 proceeds to the step S805, otherwise to the step S806.

In the step S805, the camera controller 212 determines whether the focus detection mode is the servo AF mode. In case of the servo AF mode, the camera controller 212 returns to the step S801 in order to repeatedly perform the photometry and the first AF until the SW2 in the operation switch 211 is turned on. On the other hand, if the focus detection mode is not the servo AF mode but the single-capturing AF mode, the camera controller 212 returns to the step S804 to consecutively monitor the retaining state of the ON operation of the SW1 in the operation switch 211 with the focus position fixed.

In the step S806, the camera controller 212 detects the operation state of the operation switch 211, and determines whether or not the SW2 is turned on. If the SW2 is turned on, the camera controller 212 proceeds to the step S807, otherwise ends this proceeding by assuming that none of the SW1 and the SW2 in the operation switch 211 are turned on.

In the step S807, the camera controller 212 controls the main mirror 201 and the sub mirror 202 to provide the mirror-up state. Then, the camera controller 212 causes the image capturer 210 to perform an image capturing operation for acquiring the image capturing signal based on the setting of the charge accumulation time and the ISO speed determined from the photometric result in the step S801. The image capturer 210 photoelectrically converts an object image to acquire an image signal, and generates first RAW data as pupil division image data. The generated first RAW data is transferred to the memory 213.

The camera controller 212 generates the second RAW data and still image data (JPEG file, etc.) in a predetermined file format through predetermined image processing to the second RAW data. The camera controller 212 causes the recorder 219 to record the second RAW data and the still image data.

The camera controller 212 temporarily stores the center time of the charge accumulation time in the imaging operation in the memory 213 with reference to the time measured by an unillustrated built-in timer. Thus, the camera controller 212 proceeds to the step S808 and performs an operation as an image processing apparatus.

### Primary Rating (Steps S808, S901 to S903)

In the step S808, the camera controller 212 serving as an evaluator causes the focus detecting unit 209 to perform the second focus detection using the first RAW data transferred to the memory 213. The defocus amount detector 216 calculates the defocus amount from the result of the second focus detection (the second focus detection result). The second focus detection follows the imaging operation in the step S807 and the focus position control in the step S803 based on the first focus detection result described in the step S802 in the single sequence of this processing.

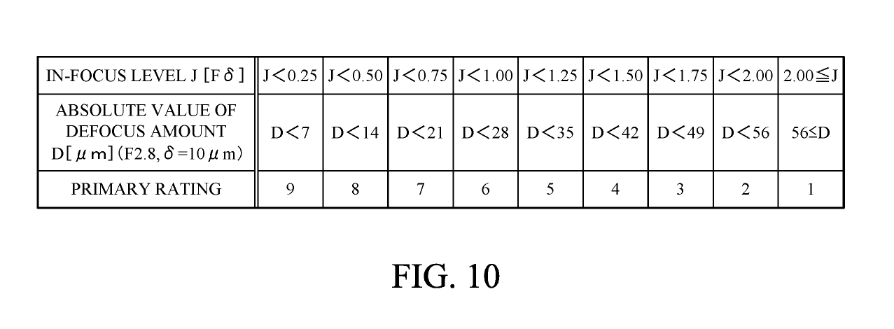

Referring now to FIG. 9, a specific description will be given of the second focus detection. First in the step S901, the camera controller 212 transfers the first RAW data from the memory 213 to the correlation calculator 214. The correlation calculator 214 extracts the image area corresponding to the focus detecting area from the transferred first RAW data and calculates a correlation value for each shift amount between the two image signals obtained from the pair of focus detecting pixel rows in the extracted image area. The phase difference detector 215 calculates the phase difference from the correlation value showing the highest correlation among the correlation values corresponding to the shift amounts. The defocus amount detector 216 acquires the reference defocus amount per unit phase difference determined for each F-number of the aperture stop 102 from the optical information recorder 107. The defocus amount detector 216 calculates the defocus amount based on the acquired reference defocus amount per unit phase difference and the phase difference calculated by the phase difference detector 215. Thereafter, the camera controller 212 proceeds to the step S902.

In the step S902, the camera controller 212 performs the primary rating (first evaluation) based on the defocus amount calculated from the second focus detection result. More specifically, the camera controller 212 initially removes a code indicating the perspective direction in the defocus amount calculated on the basis of the second focus detection result, and calculates an absolute value expression as an absolute value of a defocus amount D [μm]. Next, the absolute value of the defocus amount D is compared with a predetermined in-focus level J, and the grade is determined according to the comparison result. The in-focus level J represents a magnification with a product, as a unit amount, of a diameter δ [μm] of the permissible circle of confusion in the image data (captured image) acquired by imaging and an F-number F. As the magnification increases, the in-focus level decreases and an image blur becomes worse.

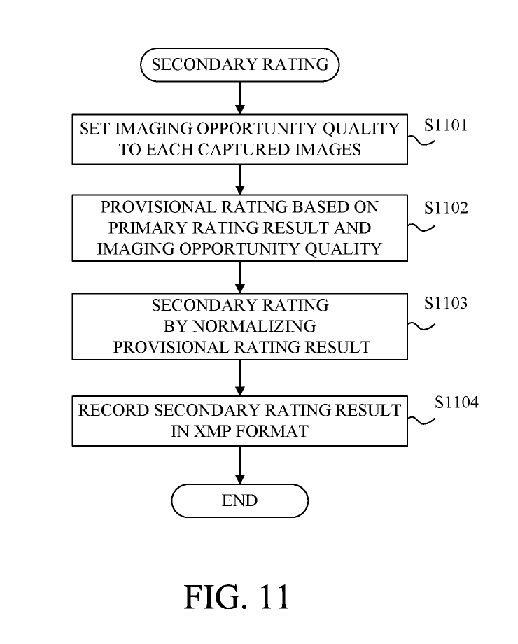

FIG. 10 illustrates a relationship between the in-focus level J [Fδ], the absolute value of the defocus amount D [μm] calculated based on the second focus detection result, and the corresponding grade. For example, assume that the F-number F of the aperture stop 102 is 2.8 and the diameter δ of the permissible circle of confusion circle is 10 [μm]. Then, when the absolute value of the defocus amount D is 7.0 [μm], the corresponding in-focus level J [Fδ] is obtained by the following expression (1).

J=7.0/(2.8×10)=0.25 (1)

The primary rating in this embodiment uses totally eleven types including nine grades with values 1 to 9 based on the in-focus level J shown in FIG. 10, a grade with an initial value 0 indicating that no rating has been performed, and a grade with a value −1 indicating that no rating has been performed or the rating has failed. This embodiment sets ten grades based on the in-focus level J, but may set a smaller or larger number of grades. The larger number of grades enables a wider defocus amount range to be rated based on the in-focus level. In addition, a finer rating based on the in-focus level is available by reducing a difference of the in-focus level between the grades. The camera controller 212 proceeds to the step S903 after determining the grades in the primary rating.

In the step S903, the camera controller 212 records the result of the primary rating in the attribute information area in the corresponding (still) image data. More specifically, as described with reference to FIG. 7, the information describing area in the Exif format is created in the marker segment “APP1” in the image data, and the “MakerNote” field is provided. Then, nine ratings with values 1 to 9 based on the in-focus level J shown in FIG. 10 are recorded in that field. This rating recording system can record more grades with a finer in-focus level difference than the rating based on the XMP format described in Literature 2. The camera controller 212 recording the primary rating result ends the primary rating. Thereafter, the camera controller 212 proceeds to the step S809 in FIG. 8.

In the step S809, the camera controller 212 determines whether or not the imaging operation mode is the still-image consecutive-capturing mode. If the imaging operation mode is the still-image consecutive-capturing mode, the camera controller 212 proceeds to the step S810. If the imaging operation mode is another imaging operation mode, this flow ends because the image data obtained by imaging has been appropriately classified and recorded.

Secondary Rating (Steps S810 to S814 and S1101 to S1104)

In the step S810, the camera controller 212 determines whether the focus detection range using the first RAW data corresponding to the captured image (still image) of interest in the consecutive capturing falls within the in-focus range (referred to as consecutive-capturing in-focus range hereinafter). The consecutive-capturing in-focus range is set separately from a segment range of the in-focus level J in determining the grade based on the in-focus level J [Fδ] described with reference to FIG. 10, and it is a predetermined range of the in-focus level J in which the captured image acquired by consecutive capturing can be regarded as an in-focus image. For example, this embodiment determines the consecutive-capturing in-focus range as a range with the in-focus level J of −1.1≤J≤+1.1 [Fδ]. If the focus detection result using the first RAW data falls within the consecutive-capturing in-focus range, the camera controller 212 proceeds to the step S811, and if it is outside the consecutive-capturing in-focus range, the flow proceeds to the step S813.

In the step S811, the camera controller 212 determines whether the first RAW data determined to fall within the consecutive-capturing in-focus range in the step S810 is the first RAW data within the first consecutive-capturing in-focus range in the series of consecutive captures while the ON operation of the SW2 continues. The camera controller 212 proceeds to the step S812 if it is the first RAW data in the first consecutive-capturing in-focus range, otherwise proceeds to the step S813.

In the step S812, the camera controller 212 temporarily stores in the memory 213 an identifier, such as a file name and a serial number, of the second RAW data (generated from the first RAW data) corresponding to the captured image of interest so that it is recognized as the header image among the plurality of consecutive in-focus images. The plurality of consecutive in-focus images, as used herein, are the targets of the secondary rating described later. In addition, the camera controller 212 temporarily stores in the memory 213 the imaging time at which the captured image of interest is acquired, as the imaging start time of each of the plurality of consecutive in-focus images. Thereafter, the camera controller 212 proceeds to the step S813.

In the step S813, the camera controller 212 again determines whether or not the focus detection result obtained from the first RAW data corresponding to the captured image of interest falls within the consecutive-capturing in-focus range, and further determines whether or not the ON operation of SW2 is continuing. These determinations are made because it is necessary to confirm the in-focus continuation state in the next captured image as long as the captured image falls within the consecutive-capturing in-focus range, and because it is necessary to repeat the focus detection, the focus position control, and the imaging operation. If the focus detection result is out of the consecutive-capturing in-focus range or the ON operation of the SW2 is not continuing, the camera controller 212 proceeds to the step S814 to set the gradient gain within the in-focus image range consecutively acquired in the consecutive capturing during the ON operation period of the SW2. If the focus detection result is within the consecutive-capturing in-focus range and the ON operation of the switch SW2 is continuing, the range of the consecutive in-focus images acquired in the consecutive capturing during the ON operation period of the SW2 is likely to further expand. Hence, the camera controller 212 proceeds to the step S817 to prepare for the next imaging operation.

In the step S814, the camera controller 212 performs the secondary rating (second evaluation). The secondary rating gives a high grade to a captured image with a high in-focus level and high imaging opportunity quality based on the primary rating result according to the in-focus level J for each captured image and the gradient gain set to each captured image.

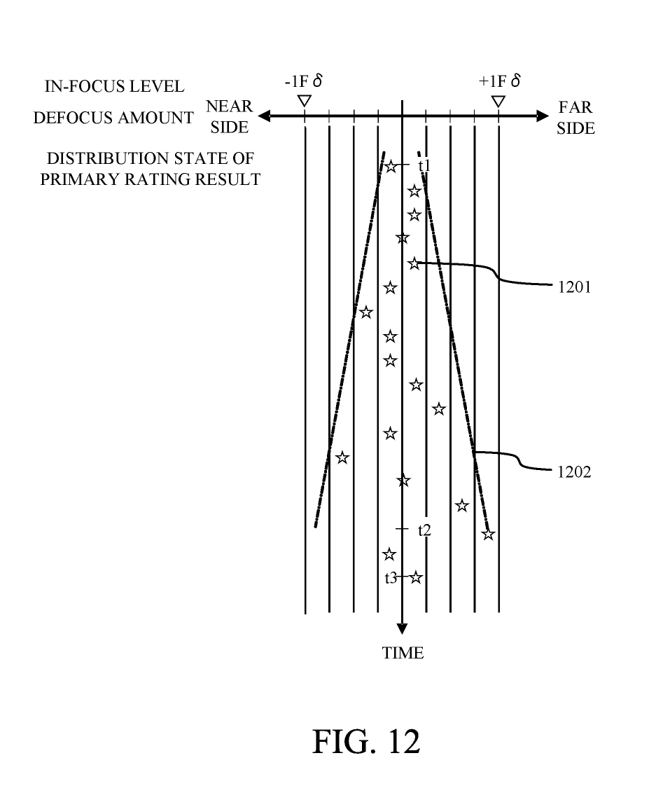

Referring now to a flowchart in FIG. 11 and FIGS. 12 to 16, a specific description will be given of the secondary rating. First, in the step S1101, the camera controller 212 sequentially reads the second RAW data of the consecutively captured images from the header image for the secondary rating target stored in the step S812 in FIG. 8 to the last captured image out of the recorder 219 and transfers them to the memory 213. The camera controller 212 causes the gradient gain setter 220 to set the gradient gain based on the imaging opportunity quality corresponding to each of the captured images.

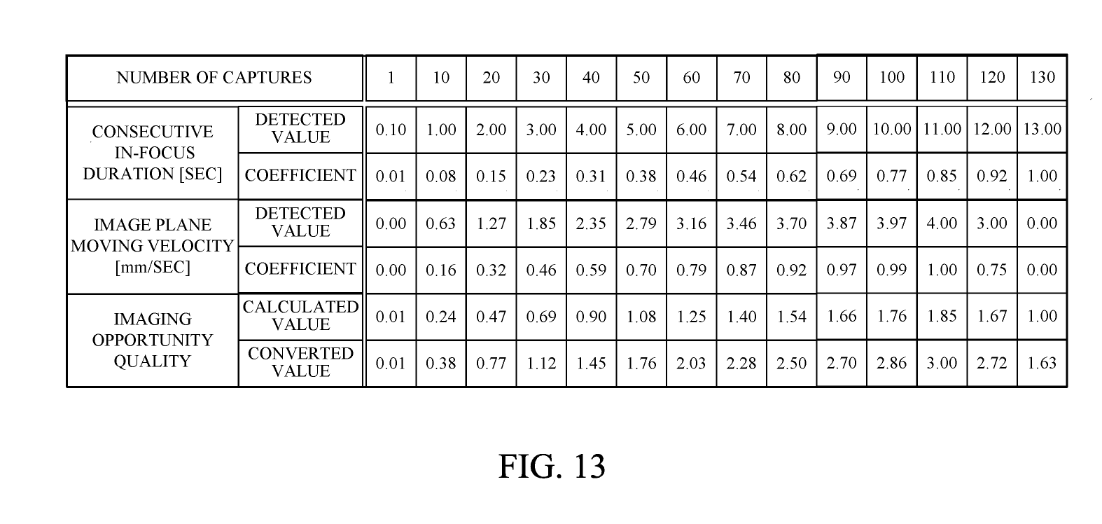

A method of setting the gradient gain will be described. FIG. 12 is an illustrative distribution of the primary rating result (or grades) based on the defocus amount when the digital camera consecutively captures still images of a short-distance runner who runs on an athlete track from a distant start point and approaches to the imaging position where the digital camera provides imaging. In FIG. 12, an abscissa axis represents a defocus amount as a focus detection result, and an ordinate axis represents a temporal variation. As described with reference to FIG. 10, the defocus amount is converted into a unit of in-focus level [Fδ] and serves as a determination index of the primary rating. The temporal variation on the ordinate axis corresponds to the elapsed time with the imaging start time of the header image for the secondary rating target as the base point in the step S812.

A plurality of asterisks 1201 represent a distribution of the captured images acquired by consecutive capturing. The consecutive capturing starts when an in-focus image is acquired by the initial imaging at time t1 during the ON operation period of the SW2, and the runner as an object approaches from the far side to the near side as time elapses. The runner reaches the goal point at time t2. Thereafter, the ON operation of the SW2 is released at time t3 through a cool down period, and the consecutive capturing ends.

An alternate long and short dash line 1202 is an auxiliary line indicating that the accuracy of the focus position control lowers as the object approaches to the imaging position with consecutive-capturing time and the defocus amounts of the captured image widely scatter. Since the runner who reached the goal point at time t2 decreases the running speed, the focus position has changed on the near side but the accuracy of the focus position control is restored again.

In FIG. 12, the imaging opportunity quality is the best near time t2 when the runner reaches the goal point. When the runner runs from the start point to the goal point (from t1 to t2), the imaging opportunity quality accompanying the object movement increases in roughly proportion to the elapsed time of the consecutive capturing. On the other hand, when the runner moves further while reducing the running velocity after reaching the goal point (t2 to t3), the relationship between the elapsed time change of the consecutive capturing along with the movement and the imaging opportunity quality has a reverse trend to the relationship between the elapsed time change of the consecutive capturing and the imaging opportunity quality from t1 to t2. In other words, the imaging opportunity quality accompanying the object movement lowers from t2 to t3, as the elapsed time of the consecutive capturing becomes longer.

When the runner moves from the start point to the goal point, the increase in the imaging opportunity quality accompanying the movement and the increase in the image plane moving velocity relative to the runner have approximately equal tendencies. When the runner reaches the goal point and then moves further while reducing the velocity, the decrease of the imaging opportunity quality and the decrease of the image plane movement velocity generally coincide with the movement.

However, when the image plane moving velocity relative to the distant runner is compared with the image plane moving velocity relative to the runner when he runs further while reducing the velocity after the goal, the imaging opportunity quality in the period from the time t2 to the time t3 close to the goal is higher than that near the time t1 due to the short extra running time.

Accordingly, this embodiment more accurately estimates the imaging opportunity quality by determining it based on both the elapsed time of the consecutive capturing and the image plane moving velocity relative to the object.

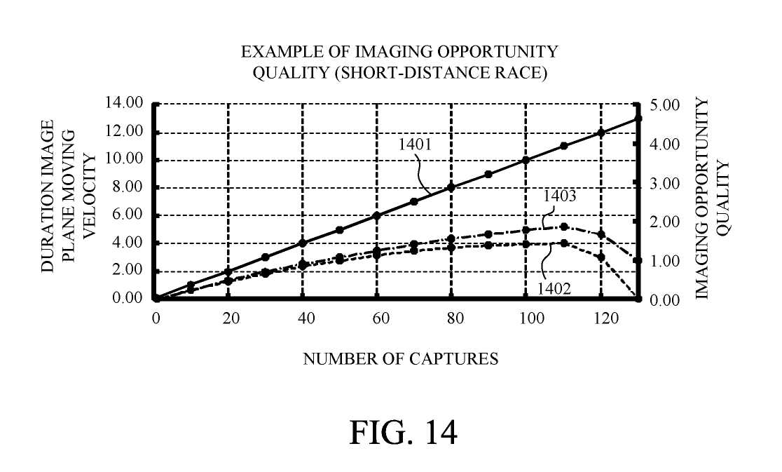

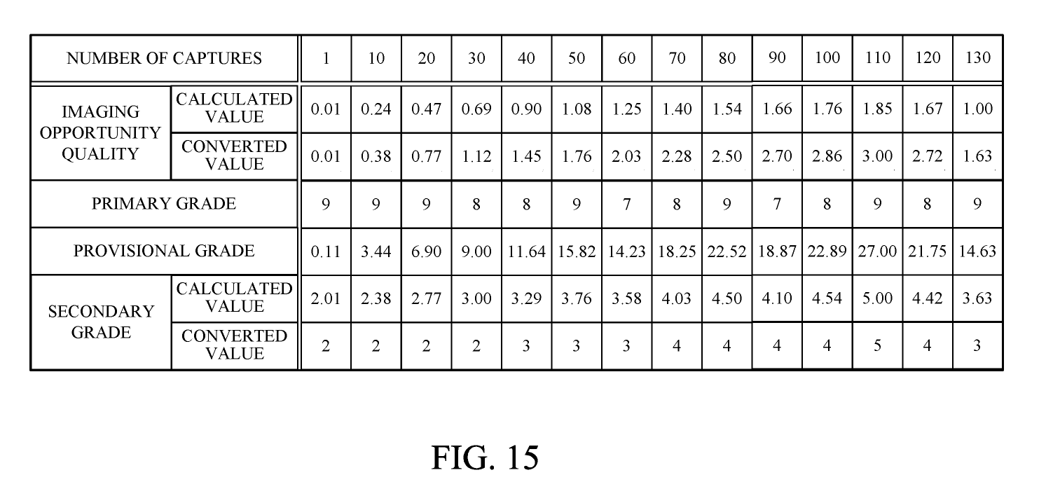

FIGS. 13 and 14 illustrate a table and a graph showing an illustrative transition of the imaging opportunity quality. The first row in the table in FIG. 13 represents the number of captures, indicating that 130 (still) images were captured after 130 consecutive captures. In the first row, the first transfer and each ten captures are shown.

The second and third rows in the table show the duration (the duration of the in-focus state: referred to as in-focus duration hereinafter) [second] since the in-focus state was first obtained in the consecutive capturing. This example captures images ten times per second in the consecutive capturing. A “detected value” in the second row illustrates a detected value of the in-focus duration by the camera controller 212 and a solid line in FIG. 14 illustrates the relationship between the number of captures and the detected value 1401 of the in-focus duration. The “coefficient” in the third row shows a value obtained by normalizing the detected value of the in-focus duration with the maximum value 1.

The fourth and fifth rows in the table show the image plane moving velocity [mm/sec] for a certain runner as an object. The image plane moving velocity is calculated based on the focus detection results at the start point and at the end point of the time measurement per unit time and the last image plane moving amount per unit time by the focus position control through the lens driving unit 103. A “detected value” at the fourth row shows the image plane moving velocity actually detected by the camera controller 212, and a broken line in FIG. 14 shows the relationship between the number of captures and an image plane moving velocity 1402. The “coefficient” in the fifth row shows a value obtained by normalizing the detection value of the image plane moving velocity in the fourth row with a maximum value 1.

Herein, in the 110th capture, the running runner passes the goal point and while the in-focus state is maintained from the start of the consecutive capturing the detected value of the image plane moving velocity at the passage time has the highest value of 4.00 [mm/sec]. The runner decreases the running speed at the 130th capture, and the consecutive capturing ends when he finally stops.

The sixth and seventh rows in the table show the imaging opportunity quality calculated based on the in-focus duration and the image plane moving velocity. The “calculated value” in the sixth row is calculated by adding the coefficient of the in-focus duration shown in the third row and the coefficient of the image plane moving velocity shown in the fifth row using the following expression (2). An alternate long and short dash line in FIG. 14 illustrates the relationship between the number of captures and imaging opportunity quality 1403. The “converted value” in the seventh row is a converted value for use with the rating and is calculated using the following expression (3).

S1=t+v (2)

S2=S1/S1_MAX×R (3)

Herein, S1 is the calculated value of the imaging opportunity quality. S_ MAX is the maximum calculated value of the imaging opportunity quality in the in-focus image obtained by consecutive capturing. t is the coefficient of in-focus duration. v is the coefficient of an image plane moving velocity. S2 is the converted value of the imaging opportunity quality. R is the number of grades in the rating.

The calculated imaging opportunity quality monotonically increases until the runner passes the goal point at the 110th capture and monotonously decreases until the he stops at the 130th capture. The imaging opportunity quality at the 130th capture is as follows: The image plane moving velocity as one standard is 0 [mm/sec], but the reduction is suppressed by the increase of the in-focus duration as another standard. As a result, the imaging opportunity quality has the highest value near the goal point and decreases with time or velocity from the goal point. Thus, among the plurality of in-focus images obtained by consecutive capturing, the captured image can be efficiently referred to in descending order of imaging opportunity quality near the goal.

In the step S1101 in FIG. 11, the camera controller 212 sets the converted value of the imaging opportunity quality calculated as described above as a gradient gain to be multiplied by the primary rating result in the secondary rating described later to the corresponding captured image. Thus, the camera controller 212 proceeds to the step 1102.

In the step S1102, the camera controller 212 once ignores the number of grades and multiplies the primary rating result in the step S808 by the gradient gain set in the step S1101 for provisional rating.

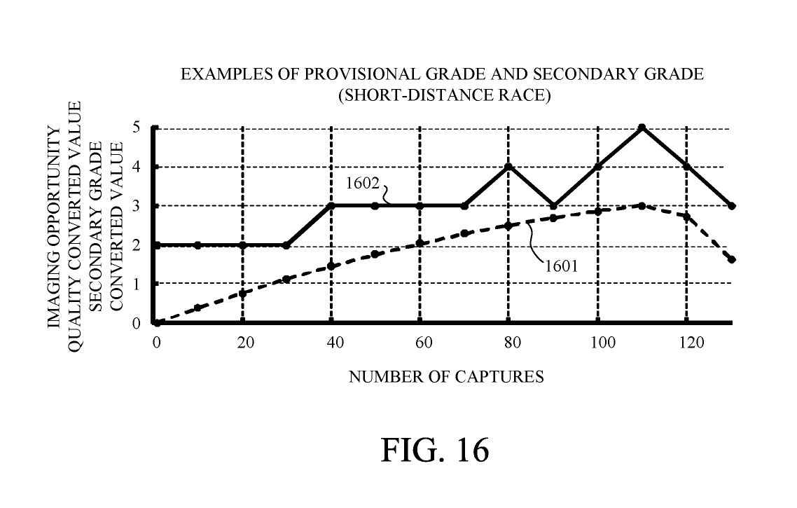

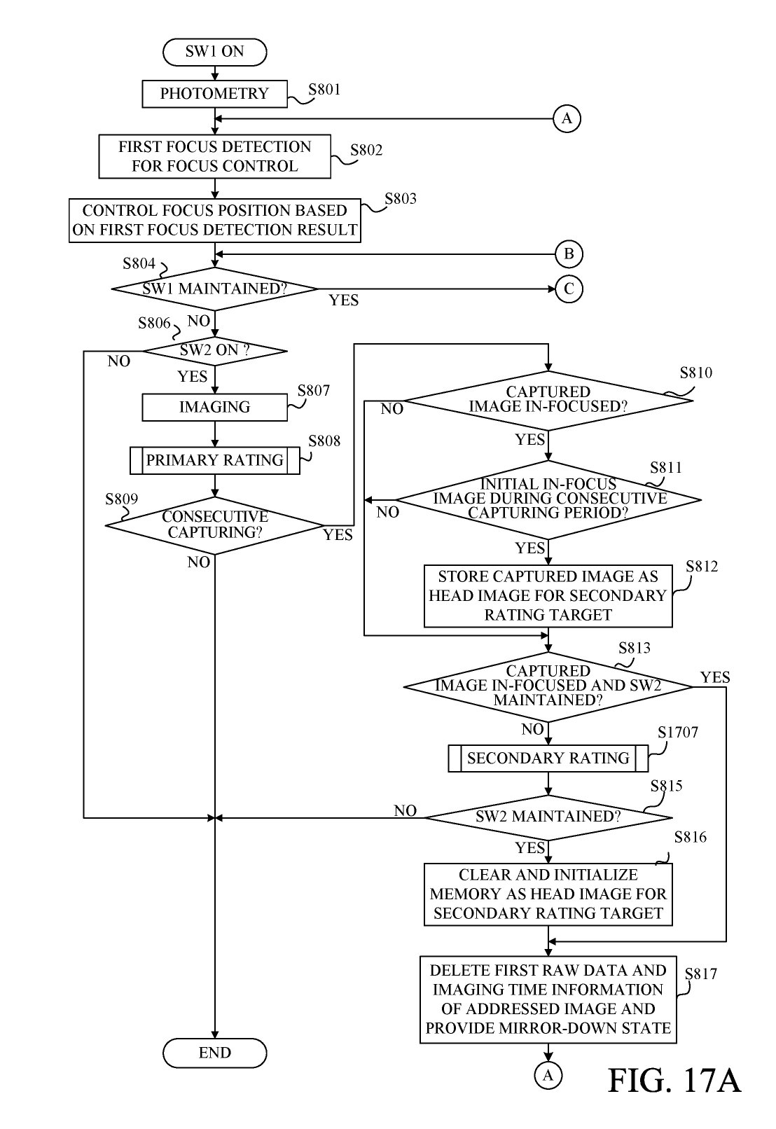

FIGS. 15 and 16 are tables for explaining the provisional rating and secondary rating described later. The first row in the table in FIG. 15 shows the number of captures described with reference to FIG. 13, and the second row shows the calculated value of the imaging opportunity quality. The third row in the table shows the converted value of the imaging opportunity quality, and the fourth row shows the illustrative primary rating result (the primary grade) set based on the defocus amount of the focus detection in each capture described with reference to FIG. 10. The fifth row in the table shows the provisional grade obtained by once ignoring the number of grades and by multiplying the gradient gain as the converted value of the imaging opportunity quality by the primary grade. Thereafter, the camera controller 212 proceeds to the step S1103.

In the step S1103, the camera controller 212 performs a normalization such that the grade by the provisional rating falls within a predetermined number of grades, and performs the secondary rating to determine the grade to be finally recorded in association with the captured image.

In order to record the rating result in the later stage in the Rating field in the XMP format disclosed in Literature 2 described with reference to FIG. 7, this embodiment previously gives a significance to the value of the grade. The grade of a value 0 means the initial value that has not been rated yet. The grade of a value 1 means the defocus amount as the focus detection result out of the consecutive-capturing in-focus range described in the step S810. This embodiment sets the consecutive-capturing in-focus range calculated from the threshold value of the predetermined defocus amount, the F-number, and the diameter of the permissible circle of confusion, for example, to −1.1≤J≤+1.1 [Fδ]. The grade of a value of 1 is assigned to the defocus image with a defocus amount outside the consecutive-capturing in-focus range. The grades of values of 2 to 5 mean the defocus amount within the in-focus determination range, while a higher value means a higher defocus amount and higher imaging opportunity quality.

In this step, the camera controller 212 performs a normalization such that the provisional grade assigned in the step S1102 becomes one of four grades of the values 2 to 5 using the following expression (4) and obtains the secondary rating result.

G=K×(L/K_MAX)+M (4)

Herein, G is the calculated value of the secondary grade. K is the provisional grade. K_MAX is a maximum value of the provisional grade in the in-focus image obtained by consecutive capturing. L is the number of grades including the grades set by the normalization. M is the minimum value of the grade in the consecutive-capturing in-focus range.

The sixth row in the table in FIG. 15 shows the secondary rating result (secondary grade) obtained by normalizing the provisional grade as described above. Since the Rating field in the XMP format is represented by an integer value, the secondary grade is finally calculated as a converted value converted into an integer as illustrated in the seventh row in the table in FIG. 15. As illustrated in the graph of FIG. 16, a converted value 1602 of the secondary grade adequately reflects a converted value 1601 of the imaging opportunity quality, and finally the grade for the captured image near the goal point in which both the in-focus level and the imaging opportunity quality are high is the highest among the secondary grades. The camera controller 212 that has performed the secondary rating proceeds to the step S1104.

In the step S1104, the camera controller 212 records the secondary rating result obtained in the step S1103 in the attribute information area in the corresponding captured image (still image data). More specifically, as described with reference to FIG. 7, an information describing area in the XMP format is created in the marker segment “APP1” in the still image data, and the “Rating” field is provided. Then, that field records the value 0 indicating that no grades of the values 2 to 5 shown in FIG. 15 or no rating has been performed or the value 1 indicating the outside of the consecutive-capturing in-focus range. This rating recording system can share the grades expressing the in-focus level and the imaging opportunity quality with devices made by other manufacturers with high compatibility. The camera controller 212 having recorded the secondary rating result in this way ends the secondary rating and the operation of the step S814 in FIG. 8. Then, the camera controller 212 proceeds to the step S815.

In the step S815, the camera controller 212 determines whether or not the ON operation of the SW2 in the operation switch 211 is continuing. If the ON operation of the SW2 is continuing, the camera controller 212 proceeds to the step S816. If the ON operation of the SW2 is not continuing, a series of consecutive captures are completed and the secondary rating is also completed, so this processing ends.

In the step S816, the camera controller 212 deletes the stored information on the header image for the secondary rating target stored in the step S812 from the memory 213 for initialization. Thereafter, the camera controller 212 proceeds to the step S817.

In the step S817, the camera controller 212 deletes the imaging time corresponding to the first RAW data and the captured image of interest from the memory 213 for initialization. The camera controller 212 shifts the camera portion 200 to the mirror-down state, and then returns to the step S801 again for the next consecutive capturing.

This embodiment provides the following operational effects. In referring to a series of consecutively captured images within a predetermined in-focus range, prior art is likely to select an image that can be easily focused by the focus potion control or have low imaging opportunity quality, such as a captured image of a short-distance runner apart from the goal point. On the other hand, this embodiment can prevent an image having high imaging opportunity quality from being buried, such as a captured image of a runner near the goal, in a plurality of captured images acquired by consecutive capturing in which the in-focus state is obtained by the focus position control.

### <Variation>

In the steps S813 and S815 in FIG. 9, the camera controller 212 determines whether or not the ON operation of the SW2 in the operation switch 211 is continuing. Rather, it may be determined whether or not the ON operation of the SW1 in the operation switch or the ON operation of the SW2 is continuing. If the user maintains the ON operation of the SW1 after the series of consecutive captures and the continuous in-focus state continues, the consecutive capturing can be resumed by the next ON operation of the SW2. Thus, by determining that the ON operation of the SW1 is continuing, the plurality of captured images can be considered to be acquired in the consecutive in-focus state intentionally acquired by the user, thereby the user convenience improves.

According to this embodiment, the camera controller 212 performs the primary rating for each segmented range of the in-focus level J [Fδ] corresponding to the defocus amount, as illustrated in FIG. 10. At this time, as the in-focus level J [Fδ] is smaller or the in-focus state is higher, a larger value is set as the primary grade. Alternatively, as the value of the in-focus level J [Fδ] is smaller, a smaller value may be set as the primary grade. As illustrated in FIG. 15, in setting a smaller value as the primary grade as the value of the in-focus level J [Fδ] is smaller, a smaller value may be also set to the secondary grade.

For example, in the primary rating in the step S902 in FIG. 9, when nine grades with the values 1 to 9 are used, the value 1 means the most strictly focused. In this case, when the secondary rating shown in the step S1103 in FIG. 11 uses the 5 grades of the values 1 to 5, the four grades of the values 1 to 4 may be expressed in the consecutive-capturing in-focus range, and the grade of the value 5 may express the outside of the consecutive-capturing in-focus range.

According to this embodiment, the camera controller 212 determines whether the focus detection result falls within the consecutive-capturing in-focus range in the steps S810 to S813 in FIG. 8. However, in addition to this determination condition, the camera controller 212 may also determine whether or not the driving direction of the focus lens in the lens driving unit 103 (referred to as the focus driving direction hereinafter) is reversed. The camera controller 212 may determine whether or not there are a plurality of continuous in-focus images including a presence or absence of the reversal of the focus driving direction.

When the focus position control is reversed from the focus driving (simply referred to as the focus driving hereinafter) in the near direction to the focus driving in the infinity direction, the camera controller 212 may change the gradient gain level in the step S1101. More specifically, the camera controller 212 sets a gradient gain having a maximum value gain higher than that of another captured image, to a captured image acquired when the focus position control (the moving direction of the focus position) changes from the near direction to the infinity direction (as soon as the direction is reversed).

Then, the camera controller 212 sets a gradient gain of a predetermined minimum value to a captured image obtained as soon as the ON operation of the SW2 is released, and sets to each captured image a gradient gain that gradually decreases the coefficient from the captured image at the reversal moment to the captured image as soon as the ON operation of the SW2 is released. This processing operation enables the imaging opportunity quality to be more accurately determined.

On the other hand, when the focus position control is reversed from the focus driving in the infinity direction to the focus driving in the near direction, the camera controller 212 may perform the same operation as that when it determines the first focus detection result is out of the consecutive-capturing in-focus range. Thereby, a more appropriate gradient gain can be set to each of a plurality of consecutive in-focus images since the imaging opportunity quality has the minimum value.

### Second Embodiment

The first embodiment sets the imaging opportunity quality from the predetermined minimum value to the predetermined maximum value in the consecutive capturing in the consecutive in-focus state started with the ON operation of the SW2 of the operation switch 211, and performs the rating for the captured images. On the other hand, this embodiment sets the servo AF mode and changes the predetermined minimum value in the imaging opportunity quality according to the focus detection state while the focus position control is repeatedly performed according to the ON operation of the SW1 before the consecutive capturing corresponding to the ON operation of SW2 is started.

More specifically, when the in-focus state is consecutively obtained by repeating the focus position control for the object moving in the perspective direction in accordance with the ON operation of the SW1 in the servo AF mode and the consecutive capturing is started, it is determined that the imaging opportunity quality has already increased to some extent. Whether or not the object is moving in the perspective direction is determined by detecting that the two movements of the focus position of the object had the same moving direction among the near direction and the infinity direction based on three or more results in the first focus detection while the SW1 is turned on.

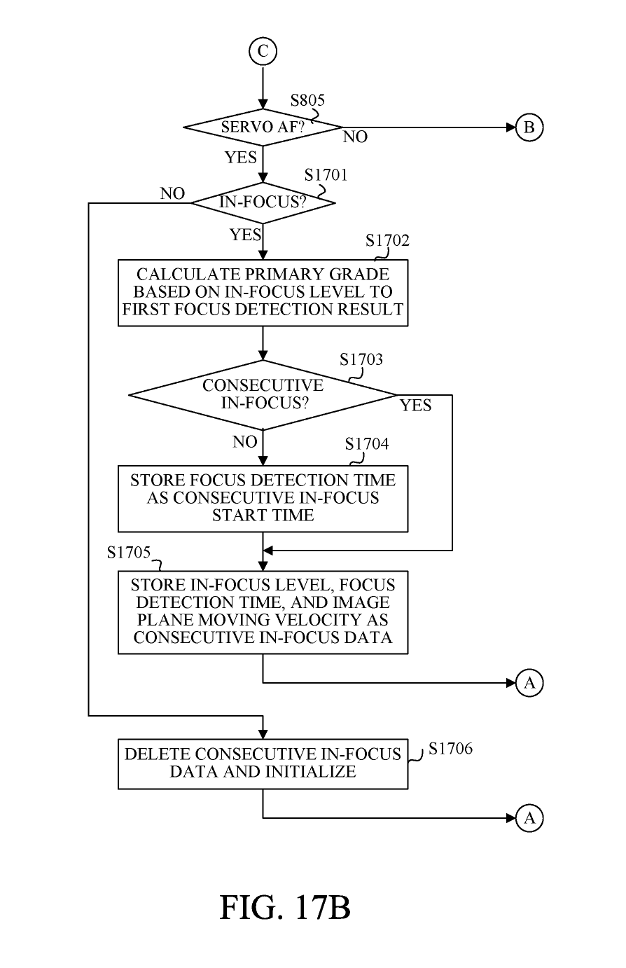

A flowchart of FIGS. 17A and 17B illustrates processing (imaging operation and image rating operation) executed by the digital camera according to this embodiment. The camera controller 212 executes this processing in accordance with a computer program. A description will now be given of a difference from the first embodiment, and a description common to the first embodiment will be omitted.

In the initial state just after the digital camera according to this embodiment is powered on, the still-image single-capturing mode or the still-image consecutive-capturing mode is set in the mirror-down state, and the user can view the object image through the viewfinder 206. Then, the SW1 in the operation switch 211 is turned on by the user and the processing for the imaging operation starts with the step S801, and the same operation is performed as the steps S801 to S813 in FIG. 8. In this embodiment, unlike the first embodiment, in the step S805, the camera controller 212 proceeds to the step S1701 if the focus detection mode is the servo AF mode.

In the step S1701, the camera controller 212 determines whether or not the defocus amount as the first focus detection result obtained in the step S802 falls within a predetermined consecutive-capturing in-focus range. As described with reference to FIG. 10 in the first embodiment, the predetermined consecutive-capturing in-focus range is an in-focus range set to the consecutive capturing which corresponds to the in-focus level J of −1.1≤J≤+1.1 [Fδ] calculated using the expression (1) described in the first embodiment. Although the first focus detection result is calculated from the output of the focus detecting unit 209, the F-number F used to calculate the focus level J is not the F-number of the secondary optical system aperture stop 605 but is the F-number of the aperture stop 102 in the lens unit portion 100. This F-number is controlled in the step S807 in FIGS. 17A and 17B which will be described later.

This step uses the F-number of the aperture stop 102 to calculate the in-focus level J [Fδ] with the expression (1) so as to unify the units with the in-focus level J [Fδ] calculated in the subsequent step for easy comparison purposes. If the defocus amount falls within the predetermined consecutive-capturing in-focus range, the camera controller 212 proceeds to the step S1702, otherwise proceeds to the step S1706.

In the step S1702, the camera controller 212 calculates the absolute value of the defocus amount D [μm] that expresses the defocus amount as the first focus detection result in an absolute value. The camera controller 212 calculates the in-focus level J [Fδ], which uses as a unit amount the product of the diameter δ[μm] of the permissible circle of confusion in the captured image and the F-number F of the aperture stop 102 with the expression (1) described in the first embodiment. This step is different from the step S902 in using the first focus detection result instead of the second focus detection result as the focus detection result. Thereafter, the camera controller 212 proceeds to the step S1703.

In the step S1703, the camera controller 212 determines whether or not the first focus detection result falls within the consecutive-capturing in-focus range in the step S1701 in three or more consecutive first focus detections in the past. If the camera controller 212 consecutively determines that it is within the consecutive-capturing in-focus range, the camera controller 212 proceeds to the step S1705, otherwise to the step S1704.

If the last first focus detection result falls within the consecutive-projection in-focus range, but the second last first focus detection result is outside the consecutive-projection in-focus range, the camera controller 212 proceeds to the step S1704. In the first focus detection at this time, the ON operation of the SW1 in the operation switch 211 is continued, and the next and subsequent first focus detection results are consecutively determined as the in-focus state, forming the header of the consecutive in-focus period. The camera controller 212 temporarily stores in the memory 213 the center time of the charge accumulation time of the focus detecting sensor 608 in the first focus detection as the start time of the consecutive in-focus period. Thereafter, the camera controller 212 proceeds to the step S1705.

In the step S1705, the camera controller 212 calculates the image plane moving velocity relative to the object based on the center time of the charge accumulation time of the focus detecting sensor 608 in the first focus detection, the second last first focus detection result in which the ON operation of the SW1 is continued. More specifically, the camera controller 212 calculates the image plane moving velocity based on the positions of the focus lens (detected by the lens position detector 105) in the last and second last first focus detections, the center time of the charge accumulation time of the focus detecting sensor 608, and the first focus detection results using the following expression (5).

V=[(D₁+P₁)−(D₂+P₂)]/(T₁−T₂) (5)

Herein, V is an image plane moving velocity, D₁ is the defocus amount as the last first focus detection result, D₂ is the defocus amount as the second last first focus detection result. T₁ is the center time of the charge accumulation time in the last first focus detection. T₂ is the center time of the charge accumulation time in the second last first focus detection. P₁ is the focus lens position in the last first focus detection. P₂ is the focus lens position in the second last first focus detection.

Where the first focus detection in the past has been performed a plurality of times while the ON operation of the SW1 is continued, the image plane moving velocity is multiplied by the least-squares method using those focus detection results or the like and a differential value in a higher-degree equation. Thereby, the image plane moving velocity can be more accurately calculated.

The camera controller 212 temporarily stores, as consecutive in-focus data in the memory 213, the in-focus level J [Fδ] calculated from the first focus detection result, the center time of the charge accumulation time, and the calculated image plane moving velocity. The camera controller 212 returns to the step S801 to repeat the photometry, the focus detection, and the focus position control until the SW2 in the operation switch 211 is turned on.

When the first focus detection result is out of the consecutive-capturing in-focus range in the step S1701, the camera controller 212 proceeds to the step S1706. In this case, it is unnecessary to determine whether or not there is consecutive in-focus. Therefore, in the step S1706, the camera controller 212 initializes continuous in-focus data that contains the start time of the consecutive in-focus period, the focus level J, the focus detection time, and the image plane moving velocity, and is likely to be temporarily stored in the memory 213 through the past operations of the steps S1704 to S1705. After this initialization, the camera controller 212 returns to the step S801 in order to repeat the photometry, the focus detection, and the focus position control until the SW2 in the operation switch 211 is turned on.

In this embodiment, unlike the first embodiment, the camera controller 212 proceeds to the step S1707 when the condition is not satisfied that the first RAW data is within the consecutive-capturing in-focus range and the ON operation of the SW2 is continuing in the step S813.

In the step S1707, the camera controller 212 performs the secondary rating that provides a high grade to a captured image having a high in-focus level and high imaging opportunity quality using the primary rating result based on the first focus detection result for each captured image and the gradient gain set to each captured image.

The secondary rating herein is similar to that described in the step S814 in FIG. 8. However, the step S814 sets a gradient gain from the primary rating result corresponding to each captured image that is consecutively in-focused. On the other hand, this step sets the gradient gain to the primary rating result based on the individual first focus detection result that is consecutively focused, regardless of whether or not an image is to be recorded. By including the consecutive in-focus period where no image is recorded, when the image is started to be recorded by consecutive capturing in the middle of the consecutive in-focus period, the primary rating result is multiplied by a gradient gain higher than the predetermined minimum value. The gradient gain within the consecutive-capturing image range is set so that the predetermined minimum value is changed. The gradient gain is set based on the primary rating result based on the first focus detection result, and the primary rating result corresponding to each captured image is multiplied by the gradient gain. Thereby, the secondary rating is carried out. Thereafter, the camera controller 212 proceeds to the step S815 in FIG. 17.

This embodiment can set a grade higher than that when the imaging opportunity quality is high when the consecutive capturing starts, in the still-image consecutive-capturing after the focus position is repeatedly controlled based on the first focus detection result.

### Third Embodiment

The first and second embodiments have discussed the second focus detection performed in the digital camera. On the other hand, according to the third embodiment, the image processing apparatus (computer) provided outside the digital camera performs the second focus detection by executing processing in accordance with a computer program. Then, using the second focus detection result, this embodiment rates the image data based on the focus state and the imaging opportunity quality. The third embodiment connects the recorder 219 in the digital camera to an external computer, and the computer performs a focus detection using the second RAW data and rates images according to the focus detection result.

Similar to the first embodiment, this embodiment stores the second RAW data including the pupil division image data in the recorder 219 as a detachable storage medium. The recorder 219 further stores the imaging time, the F-number at the imaging time, the reference lens driving amount of the mounted lens at the imaging time, the reference focus driving amount at the focus position at the recording time, and its magnification variation information in association with the second RAW data.

<Configuration of Image Processing Apparatus>

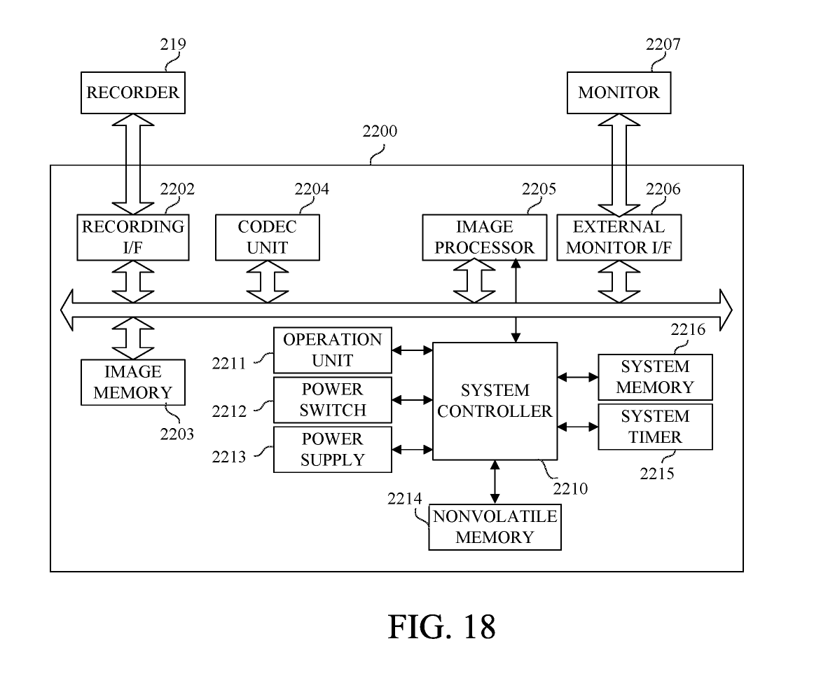

FIG. 18 illustrates a configuration of a computer as an image processing apparatus according to this embodiment. A system controller 2210 accepts image reading from the recorder 219 in response to the user operating an operation unit 2211 including a mouse, a keyboard, a touch panel, and the like. In response, the system controller 2210 causes an image memory 2203 to record the image data recorded in the recorder 219 attachable to and detachable from the computer 2200 via a recording interface (I/F) 2202.

When the image data read out of the recorder 219 is compressed and coded data, the system controller 2210 transmits the image data recorded in the image memory 2203 to a codec unit 2204. The codec unit 2204 decodes the compressed and coded image data and outputs the decoded image data to the image memory 2203. The system controller 2210 outputs the decoded image data accumulated in the image memory 2203 or the uncompressed image data such as the Bayer RGB format (RAW format) to an image processor 2205.

The image processor 2205 performs image processing for the uncompressed image data and stores the resultantly processed image data in the image memory 2203. The system controller 2210 reads the processed image data out of the image memory 2203 and outputs it to the monitor 2207 via an external monitor interface (I/F) 2206.

As illustrated in FIG. 18, the computer 2200 includes a power switch 2212, a power supply 2213, and a nonvolatile memory 2214 configured to store a computer program. The computer 2200 also includes a system timer 2215 that measures the time used for a variety of controls and the time counted by the built-in timer. The computer 2200 includes a system memory 2216 configured to store constants and variables for operations of the system controller 2210 and to develop the computer program read out of the nonvolatile memory 2214.

### <Operation of Image Processing Apparatus>

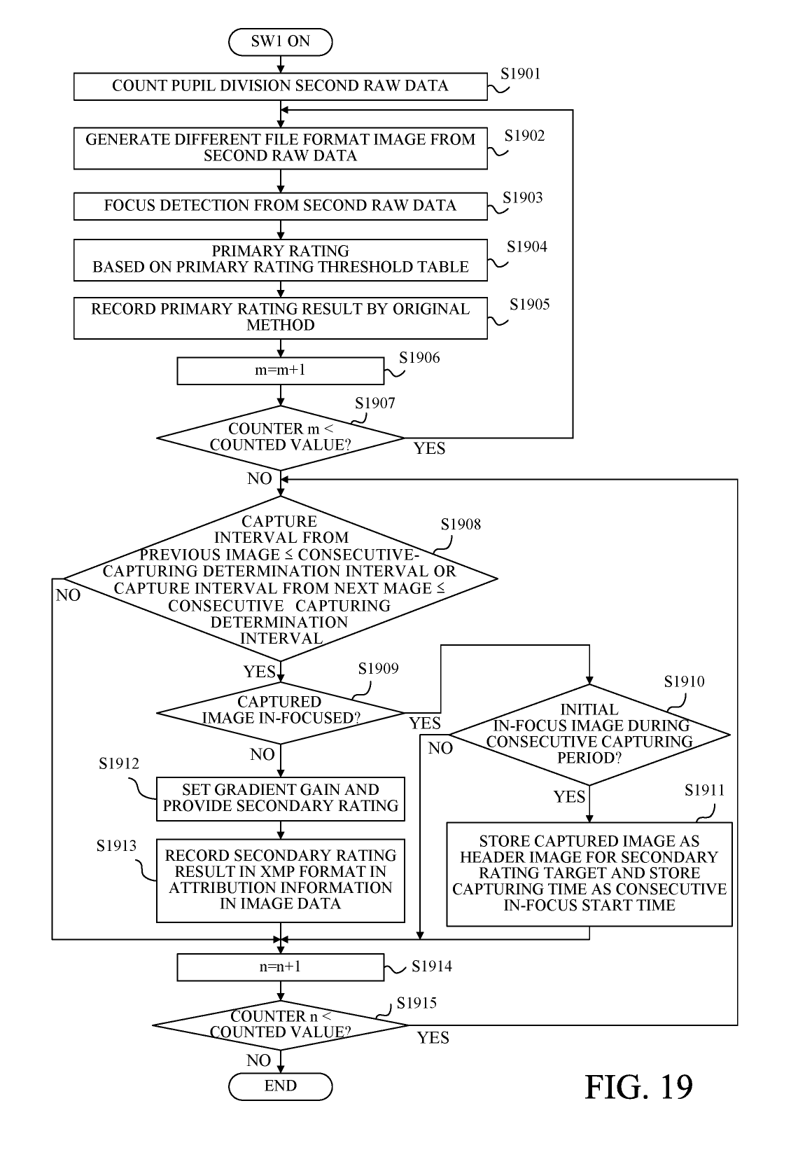

A flowchart of FIG. 19 illustrates processing (rating operation) executed by the system controller 2210 according to this embodiment. The system controller 2210 reads out of the nonvolatile memory 2214 and executes this processing in accordance with the computer program developed in the system memory 2216. The computer 2200 and the digital camera are electrically connected to each other and can communicate with each other, and the computer 2200 can read various data recorded in the recorder 219 in the digital camera. The system controller 2210 serves as an acquirer and an evaluator.

First, in response to an operation instructed by the user to start the image rating, the system controller 2210 proceeds to the step S1901. In the step S1901, the system controller 2210 reads out all links for the second RAW data of the image data designated by the user operation, and temporarily stores them in the image memory 2203 in the computer 2200. The system controller 2210 counts the number of second RAW data temporarily stored in the recorder 219. Hence, the system controller 2210 proceeds to the step S1902.

In the step S1902, the system controller 2210 reads out of the recorder 219 one second RAW data corresponding to the link (referred to as second RAW data of interest hereinafter) among one or more second RAW data temporarily stored in the recorder 219. Then, the system controller 2210 performs various image processing for the second RAW data of interest and generates still image data in a predetermined file format. Thereafter, the system controller 2210 proceeds to the step S1903.

In the step S1903, the system controller 2210 performs a focus detection using the second RAW data of interest. More specifically, the system controller 2210 reads out two image signals, the F-number at the recording time, the reference focus driving amount, and the variation magnification included in the second RAW data of interest. Then, the system controller 2210 extracts the image area corresponding to the focus detecting area from the second RAW data of interest, and calculates the correlation value for each shift amount between the two image signals in the extracted image area. The system controller 2210 specifies the correlation value indicating the highest correlation among the calculated correlation values and calculates the phase difference from the shift amount between the two image signals giving the correlation values.

The system controller 2210 that calculates the phase difference calculates the defocus amount based on the phase difference, the F-number, and the reference defocus amount. Thereafter, the system controller 2210 proceeds to the step S1904.

In the step S1904, the system controller 2210 performs the primary rating based on the calculated defocus amount. The primary rating in this step is the same as the primary rating described in the step S902 in FIG. 9, and determines the grade by comparing the absolute value of the defocus amount and the in-focus level J with each other. Thereafter, the system controller 2210 proceeds to the step S1905.

In the step S1905, the system controller 2210 records the primary rating result in the attribute information area of the corresponding image data. More specifically, as described in FIG. 7, an information describing area in the Exif method is created in the marker segment “APP1” in the image data, and a “MakerNote” field is provided. Nine grades with values 1 to 9 based on the focus level J shown in FIG. 10 are recorded in the field. This rating recording system can record the grades more than those in the rating based on the XMP format described in Literature 2, although the compatibility with other manufacturers is low. Thereafter, the system controller 2210 proceeds to the step S1906.

In the step S1906, the system controller 2210 increments the value 1 to the counter m in the second RAW data for which the focus detection is completed. Thereafter, the system controller 2210 proceeds to the step S1907.

In the step S1907, the system controller 2210 compares the value of the counter m in the second RAW data for which the focus detection is completed with the counted value of the second RAW data counted in the step S1901. If the value of the counter m is smaller than the counted value, the system controller 2210 returns to the step S1902 in order to perform the image processing and focus detection for the second RAW data of interest. Then, the operations from the step S1902 to the step S1906 are performed for all the second RAW data that are temporarily stored. If the value of the counter m is equal to or larger than the measured value, since the system controller 2210 has already read out all the second RAW data of interest stored in the recorder 219, the system controller 2210 proceeds to the step S1908.

In the step S1908, the system controller 2210 determines whether the second RAW data of interest is consecutive-capturing image data acquired by imaging in the still-image consecutive-capturing mode. Herein, the system controller 2210 makes the above determination by comparing the imaging time of the second RAW data of interest with the imaging time of the second RAW data before and after the second RAW data of interest. More specifically, when any one of the intervals between the imaging time of the second RAW data of interest and the imaging times before and after the focused second RAW data is within the predetermined consecutive-capturing imaging interval, the system controller 2210 determines that the second RAW of interest is image data acquired by imaging in the still-image consecutive-capturing mode.

For example, in performing four to ten captures per second in the consecutive capturing in the still-image consecutive-capturing mode, the system controller 2210 sets a consecutive-capturing imaging interval as a determination threshold based on the lowest consecutive-capturing velocity that is four captures per one second to ¼ seconds. The system controller 2210 proceeds to the step S1909 for the next operation of the second RAW data of interest if the imaging time interval is within the consecutive-capturing imaging interval, and proceeds to the step S1914 to address the second RAW data if it is beyond the consecutive-capturing imaging interval.

In the step S1909, the system controller 2210 determines whether or not the focus detection result of the second RAW data of interest calculated in the step S1903 is within the consecutive-capturing in-focus range, such as −1.1≤J≤+1.1 [Fδ], described in the first embodiment with reference to FIG. 10. If the focus detection result is within the consecutive-capturing in-focus range, the system controller 2210 proceeds to the step S1910, otherwise proceeds to the step S1912.

In the step S1910, the system controller 2210 determines whether or not the second RAW data of interest in which the focus detection result is determined within the consecutive-capturing in-focus range is the initial in-focus image in the series of consecutive captures. Whether it is the initial in-focus image can be determined by determining whether the consecutive-capturing image data obtained by imaging is out of the consecutive-capturing in-focus range before the imaging that provides the second RAW data of interest. If the second RAW data of interest is the initial in-focus image, the system controller 2210 proceeds to the step S1911, otherwise proceeds to the step S1914 to address the next second RAW data so as to check the continuation of the in-focus state in the series of consecutive captures.

In the step S1911, similar to the step S812 in FIG. 8 according to the first embodiment, the system controller 2210 temporarily stores the recognition result in the built-in memory which sets the second RAW data of interest to the header image in a plurality of consecutive in-focus images for the secondary rating target. The system controller 2210 temporarily stores the imaging time of the second RAW data of interest as the imaging start time of a plurality of consecutive in-focus images in the built-in memory. Thereafter, the system controller 2210 proceeds to the step 51904.

On the other hand, in the step S1912, the system controller 2210 performs the secondary rating in the same manner as that in the step S814 in FIG. 8 and steps S1101 through S1103 in FIG. 11 in the first embodiment. The first embodiment performs the secondary rating based on the set value related to the imaging and focus detection maintained by the camera controller 212 and the first RAW data, but the system controller 2210 in this embodiment performs the secondary rating based on the second RAW data. Thereafter, the system controller 2210 proceeds to the step S1913.

In the step S1913, the system controller 2210 records the secondary rating result in the attribute information area in the corresponding still image data in the same way as in the step S1104 in FIG. 11 according to the first embodiment. Thereafter, the system controller 2210 proceeds to the step S1914.

In the step S1914, the system controller 2210 increments the value 1 to the counter n of the second RAW data for which the secondary rating is completed. Thereafter, the system controller 2210 proceeds to the step S1915.

In the step S1915, the system controller 2210 compares the value of the counter n of the second RAW data for which the secondary rating is completed with the counted value of the second RAW data counted in the step S1901. If the value of the counter n is smaller than the counted value, the system controller 2210 returns to the step S1908 so as to determine whether or not the second RAW data that is not addressed is a consecutively captured image and to carry out the secondary rating as necessary. Then, the operations from the step S1908 to the step S1913 are performed for all the temporarily stored second RAW data. If the value of the counter m is equal to or larger than the measured value, the system controller 2210 finishes the present processing because all the second RAW data of interest stored in the recorder 219 has been read out.

This embodiment performs the second focus detection in the external device different from the digital camera, and the rating based on the second focus detection result. Performing the rating processing on the external device instead of the digital camera can reduce the processing load in imaging by the digital camera. Similar to the first embodiment, the still image data obtained by actual imaging can be classified based on the grade that depends on the focus state and the imaging opportunity quality. Thereby, it is possible to reduce the burden of the user who classifies the image data obtained by imaging.

### Modification

### <Modification Relating to Processing in Mirror-Up>

The still-image single-capturing mode and the still-image consecutive-capturing mode described in each of the above embodiments relate to a modes (first mode) in which the first focus detection is performed in the mirror-down state. However, there may be a mode (second mode) in which the first focus detection is performed in the mirror-up state. The live-view mode and the motion-image capturing mode are different from the still-image single-capturing mode and the still-image consecutive-capturing mode in that the first focus detection is performed in the mirror-up state so that the main mirror 201 and the sub mirror 202 are controlled to provide the mirror-up state.

When the live-view mode is set by the user operation on the operation unit 218, the main mirror 201 and the sub mirror 202 are controlled to provide the mirror-up state. In the live-view mode, the image capturer 210 consecutively captures images at a predetermined cycle such as 60 captures per second, and an image is displayed on the display unit 217 using the obtained image signal.

When the SW1 in the operation switch 211 is turned on in the live-view mode, the first photometry operation measures the luminance of the object image with the image signal of the image capturer 210. Based on the photometric result obtained by the first photometry operation, the aperture diameter of the aperture stop 102, the charge accumulation time of the image capturer 210, and the ISO speed are controlled. The first focus detection follows the first photometric operation and uses the two image signals from the image capturer 210, and the focus position control of the imaging optical system is performed based on the first focus detection result.

When the SW2 is turned on in the live-view mode, the image capturer 210 performs the imaging operation for recording, and the image capturer 210 generates the first RAW data as the pupil division image data from the image signal. Then, the second RAW data for recording is obtained by converting the first RAW data into a predetermined RAW file format, and recorded in the recorder 219. The second RAW data includes the pupil division image data.

A pair of pixel signals obtained by pupil division are added to the first RAW data, and receive predetermined image processing to provide still image data, which is recorded in the recorder 219. The first RAW data is transferred to the memory 213 and used for the second focus detection based on the pupil division image data. The second photometric operation measures the luminance of the object image with the image signal from the image capturer 210. The aperture diameter of the aperture stop 102, the charge accumulation time and the ISO speed of the image capturer 210 are controlled based on the result of the second photometry operation.

When the motion image recording mode is set by the user operation on the operation unit 218, the main mirror 201 and the sub mirror 202 are controlled to provide the mirror-up state. In the motion image recording mode, the image capturer 210 consecutively captures images at a predetermined cycle, such as 60 captures per second, and displays the images on the display unit 217 by using the obtained image capturing signal.

In the motion image recording mode, in response to the user operation instructing the operation unit 218 to start the motion image recording, the image capturer 210 generates the first RAW data as the pupil division image data from the captured image. A pair of pixel signals obtained by the pupil division are added to the first RAW data, and receive the predetermined image processing to provide the motion image data recorded in the recorder 219. The generated first RAW data is transferred to the memory 213 and used for first and second focus detections based on the pupil division image data. The second photometric operation measures the luminance of the object image with the image signal of the image capturer 210. The aperture diameter of the aperture stop 102 and the charge accumulation time and ISO speed of the image capturer 210 are controlled based on the photometric result obtained by the second photometric operation.

In the still-image single-capturing mode and the still-image consecutive-capturing mode, the first focus detection determines the target focus position of the focus position control with the focus detecting unit 209 in the mirror-down state. On the other hand, the live-view mode performs the first focus detection with the image signal in the mirror-up state, and determines the target focus position of the focus position control based on the first focus detection result. In this case, the focus position of the object image recorded in the above second RAW data or still image data is detected with the image signal obtained in the last imaging operation, and the lens portion 101 is the controlled at focus position based on the result. The second focus detection result corresponding to the second RAW data of interest can also be used as the first focus detection result in the next image. Therefore, either the first focus detection or the second focus detection may be omitted.

In each of the above embodiments, the first photometric operation determines the charge accumulation time in the imaging operation and the ISO speed using the photometric sensor 208 in the mirror-down state. On the other hand, the live-view mode performs the first photometry operation using the image signal in the mirror-up state, and determines the charge accumulation time and the ISO speed of the imaging operation based on the result. In this case, the exposure amount of the object image recorded in the second RAW data or still image data means the exposure amount based on the photometric result using the image signal obtained in the last imaging operation.

### <Modification of Application to Motion Image Frame>

The digital cameras according to the first embodiment and the second embodiment have the still-image consecutive-capturing mode that repeats the consecutive capturing for obtaining a plurality of still images by continuing the ON operation of the SW2 in the operation switch 211. The digital camera performs the primary rating and secondary rating when the consecutive capturing is performed in the still-image consecutive-capturing mode. In the motion image recording mode, the ON operation state of the SW1 in the operation switch 211 may correspond to the standby state of the motion image recording, and the ON operation state of the SW2 may correspond to the start and continuation of the motion image recording.

When the user sets the motion image recording mode on the operation unit 218, the digital camera automatically shifts to the standby state of motion image recording (consecutive image capturing). In this state, similar to the live-view mode, the image capturer 210 consecutively captures images at a predetermined cycle, such as 60 captures per second, and the first focus detection and focus position control with the cycle. In this state, the main mirror 201 and the sub mirror 202 are always controlled to the mirror-up state. Since the user cannot observe the object image through the viewfinder 206 in the mirror-up state, the motion image acquired by the image capturer 210 is displayed on the display unit 217. In the standby state of the motion image recording, the digital camera starts recording the motion image when the user instructs to start recording the motion image through the operation unit 218. The image data obtained from the image capturer 210 receives the motion-image compression and encoding and is recorded in the recorder 219 in a predetermined motion-image file format.

This motion image recording mode can perform the primary rating and the secondary rating for a plurality of frame images in a consecutive in-focus state constituting a motion image to be recorded. The same operational effects as those of the first and second embodiments can be obtained not only in the still-image consecutive-capturing but also in the motion image capturing.

### <Modification of Gradient Gain>

Each of the above embodiments necessarily sets gradient gains including a predetermined maximum value and a predetermined minimum value to captured images as a plurality of consecutive in-focus images. Alternatively, while the gradient gain of the predetermined maximum value is set to the captured image having the highest imaging opportunity quality among the plurality of consecutive in-focus images, the gradient of the gradient gain may be set to a predetermined value. In this case, a gradient gain of a predetermined minimum value is set to all of the plurality of captured images with relatively low imaging opportunity quality.

Thereby, the second grade can be set higher to a captured image with higher imaging opportunity quality and a captured image with high imaging opportunity quality can be easily extracted or referred to.

### <Modified Operation for Determining Consecutive In-focus Images>

The above embodiment performs the secondary rating while finalizing a plurality of consecutive in-focus images, when the first focus detection result is out of the consecutive-capturing in-focus range after the in-focus state continues.

After the in-focus state continues, when the number of captured images whose second focus detection results are out of the consecutive-capturing in-focus range is equal to or less than a predetermined number or the elapsed time of the captured images out of the consecutive-capturing in-focus range is equal to or shorter than a predetermined time, these captured images outside the consecutive-capturing in-focus range may be included in the plurality of consecutive in-focus images. In other words, where a plurality of consecutive captures are performed at intervals and the focus state is continuously detected during the interval or the interval is equal to or shorter than the predetermined time, the consecutive captures may be treated as a bundle of consecutive captures. A series of gradient gains may be set to a plurality of in-focus images acquired by the series of consecutive captures.

Thereby, even when a defocus image is mixed due to camera shake or another object crossing in front of the camera, or the like while still images of a specific object are consecutively captured, the specific object can be more accurately recognized in a series of in-focus images. Thereby, the gradient gain can be set appropriately.

The manual shake may be determined not simply based on the number of defocus images or the elapsed time, but based on an output from an additionally provided unillustrated orientation detector, such as an orientation sensor, an angular velocity sensor, and an acceleration sensor, which detects the orientation of the digital camera and the acceleration or angular acceleration applied to the camera. For example, when the camera changes its orientation beyond a predetermined level, the pre-change consecutive capturing and the post-change consecutive capturing may be differently treated.

An unillustrated focal length detector configured to detect the focal length of the imaging optical system in the lens portion 101 may monitor the fluctuation of the focal length at short time intervals such as 10 msec intervals, and distinguish the consecutive captures by detecting the above fluctuation velocity of the focal length equal to or higher than a predetermined velocity. More specifically, when the focal length is rapidly changed as a result of that an unillustrated zoom operation member provided on the lens portion 101 is operated after the in-focus state continues, the pre-change consecutive capturing and the post-change consecutive capturing may be differently treated even though the in-focus state continues in the second focus detection. Where the F-number of the aperture stop 102 is changed through the aperture stop control unit 106 after the in-focus state continues, the pre-change consecutive captures and the post-change consecutive captures may be differently treated. Thereby, when the F-number of the imaging optical system in the image capturer 210 changes, the relationship between the defocus amount [μm] and the in-focus level J [Fδ] can be properly determined according to the F-number.

When the focus position of the imaging optical system or the moving direction of the image plane position changes, the consecutive captures before the change of the moving direction and the consecutive captures after the change may be differently treated. In this case, when the orientation of the camera changes by a predetermined amount or more in a predetermined direction due to panning or the like, the movement of the image plane position caused by the orientation change may be ignored.

### <Modification of Third Embodiment>

The third embodiment electrically and communicatively connects the recorder 219 in the digital camera with the computer 2200 as an external device. However, a reader configured to read data from the recorder 219 in the digital camera and the external computer may be electrically and communicatively connected to each other. Alternatively, each of the recorder 219 in the digital camera, the reader configured to read data from the recorder 219, and the external computer may include a radio communication unit to establish communications without an electric (wired) connection. This configuration can also provide the same effect as that of the third embodiment.

Each of the above embodiments can appropriately evaluate each of the plurality of image data acquired by consecutive capturing based on the imaging opportunity.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-81063, filed on Apr. 20, 2018, which is hereby incorporated by reference herein in its entirety.

What is claimed is:

1. An image processing apparatus comprising:
an acquirer configured to acquire index information as an evaluation index of an imaging opportunity for each of a plurality of image data acquired by consecutive capturing of a moving object; and
an evaluator configured to evaluate each of the plurality of image data using the index information.

2. The image processing apparatus according to claim 1, wherein the evaluator provides a first evaluation that evaluates a focus state for each image data acquired by the consecutive capturing, and a second evaluation using the index information to the plurality of image data evaluated as an in-focus state by the first evaluation.

3. The image processing apparatus according to claim 2, wherein the evaluator generates a result of the second evaluation by weighting a result of the first evaluation.

4. The image processing apparatus according to claim 1, wherein the index information includes imaging time at which each of the plurality of image data is acquired, and
wherein the evaluator more highly evaluates each image data as the imaging time is later, using the index information.

5. The image processing apparatus according to claim 1, wherein the index information includes information that changes according to an imaging distance to the object, and
wherein the evaluator more highly evaluates each image data as the imaging distance is shorter, using the index information.

6. The image processing apparatus according to claim 1, wherein the index information includes an image plane moving velocity in the consecutive capturing, and
wherein the evaluator more highly evaluates each image data as the image plane moving velocity is higher, using the index information.

7. The image processing apparatus according to claim 1, wherein the index information includes a distance between a focus position and a near end in an imaging optical system used for the consecutive capturing, and
wherein the evaluator more highly evaluates each image data as the distance is shorter, using the index information.

8. The image processing apparatus according to claim 1, wherein the index information includes a size of an object image in the image data, and
wherein the evaluator more highly evaluates each image data as the size of the object image is larger, using the index information.

9. The image processing apparatus according to claim 1, wherein when a plurality of consecutive image captures are performed at intervals each of which is equal to or shorter than a predetermined time, the evaluator treats the plurality of consecutive image captures as a bundle of consecutive capturing.

10. The image processing apparatus according to claim 1, wherein when a plurality of consecutive image captures are performed at intervals and a focus state is continuously detected in the interval, the evaluator treats the plurality of consecutive image captures as a bundle of consecutive imaging.

11. The image processing apparatus according to claim 1, further comprising a face detector configured to detect a face in the image data,
wherein using the index information, the evaluator evaluates each image data when the face is not detected lower than each image data when the face is detected.

12. The image processing apparatus according to claim 1, wherein when a moving direction of a focus position of an imaging optical system used for the consecutive capturing changes from a near direction to an infinity direction, the evaluator evaluates each image data acquired when the moving direction changes lower than other image data, using the index information.

13. The image processing apparatus according to claim 1, wherein when at least one of an orientation, a focal length, and an F-number change in an imaging apparatus used for the consecutive capturing, the evaluator separately treats the consecutive capturing before the at least one change, and the consecutive capturing performed after the at least one change.

14. The image processing apparatus according to claim 1, wherein when a focus position of an imaging optical system used for the consecutive capturing or a moving direction of an image plane position of an object image changes, the evaluator separately treats the consecutive capturing before the focus position or the moving position changes and the consecutive capturing after the focus position or the moving position changes.

15. The image processing apparatus according to claim 14, wherein when an orientation of the imaging apparatus used for the consecutive capturing changes by a predetermined amount or more in a predetermined direction, the evaluator ignores a movement of the image plane position as the orientation changes.

16. An imaging apparatus comprising:
an image sensor configured to consecutively capturing images; and
an image processing apparatus that includes an acquirer configured to acquire index information as an evaluation index of an imaging opportunity for each of a plurality of image data acquired by consecutive capturing of a moving object, and an evaluator configured to evaluate each of the plurality of image data using the index information.

17. An image processing method comprising the steps of:
acquiring index information as an evaluation index of an imaging opportunity for each of a plurality of image data acquired by consecutive capturing of a moving object, and
evaluating each of the plurality of image data using the index information.

18. A non-transitory computer-readable storage medium storing a computer program that enables a computer to execute an image processing method that includes the steps of:
acquiring index information as an evaluation index of an imaging opportunity for each of a plurality of image data acquired by consecutive capturing of a moving object, and
evaluating each of the plurality of image data using the index information.
